(19) United States
(12) Patent Application Publication
(10) Pub. No.: US 2014/0322554 A1
(43) Pub. Date: Oct. 30, 2014

(54) OPTICAL FILM, POLARIZING PLATE AND LIQUID CRYSTAL DISPLAY DEVICE

(71) Applicant: FUJIFILM Corporation, Tokyo (JP)

(72) Inventors: Shusuke ARITA, Kanagawa (JP); Hiromichi FURUKAWA, Kanagawa (JP)

(73) Assignee: FUJIFILM CORPORATION, Tokyo (JP)

(21) Appl. No.: 14/260,475

(22) Filed: Apr. 24, 2014

(30) Foreign Application Priority Data
Apr. 26, 2013 (JP) 2013-094401

(51) Int. Cl. C08L 33/08; C08F 220/18; C08L 33/14

(52) U.S. Cl. CPC C08L 33/08; C08L 33/14; C08F 220/18; C08L 2203/16
USPC 428/522; 523/201; 525/223; 526/328.5

(57) ABSTRACT

An optical film contains an acrylic resin, in which at least one of a modulus of elongation on a machine direction and a modulus of elongation on a direction vertical to the machine direction is less than 2.3×10⁹ N/m² and an in-plane retardation value Re (nm) of the optical film represented by the following formula (i) satisfies the following formula (ia):

Re=(nx−ny)×d Formula (i)

ΔRe=Re(10)−Re(0)≦10 Formula (ia)

wherein, in the formulae, nx represents a refractive index in an in-plane slow axis direction of the optical film, ny represents a refractive index in an in-plane fast axis direction of the optical film, d represents a thickness (nm) of the optical film, Re(10) represents a retardation value when the optical film is stretched 10%, and Re(0) represents a retardation value in an unstretched state of the optical film.

### CROSS-REFERENCE TO RELATED APPLICATIONS

This application claims the benefit of Japanese Patent Application JP 2013-094401, filed Apr. 26, 2013, the entire content of which is hereby incorporated by reference, the same as if set forth at length.

### FIELD OF THE INVENTION

The present invention relates to an optical film, a polarizing plate and a liquid crystal display device.

### BACKGROUND OF THE INVENTION

A liquid crystal display device has been used widely more and more year by year as a space-saving image display device having low power consumption. A wide viewing angle liquid crystal mode, for example, a VA mode or an IPS mode has been put into practical use so that the demand for liquid crystal display device is also expanding rapidly in the market where the image of high quality is required, for example, in a television set.

With the expansion of use of the liquid crystal display device, a large size and texture of high quality have been required for the liquid crystal display device. On the other hand, due to the increase in size, the liquid crystal display device becomes heavy. For the purpose of reduction in weight, reduction in thickness of various members progresses.

The liquid crystal display device is constituted by a liquid crystal cell and polarizing plates provided on a viewing side (front side) and a backlight side (rear side) of the liquid crystal cell. Both of the polarizing plates are stuck on both side substrates of the liquid crystal cell with an adhesive or the like. The polarizing plate used in the liquid crystal display device ordinarily has a configuration made from a polarizer comprising, for example, a polyvinyl alcohol (PVA) film in which iodine or a dye is adsorbed and oriented and transparent protective films stuck on the front and rear sides of the polarizer. Since the PVA is hydrophilic, the polarizer is sensitive to change in temperature or humidity and tends to cause expansion and contraction depending on environmental change in the surroundings. Due to the expansion and contraction of the polarizer, the polarizing plate (stack of optical films including the polarizer) causes expansion and contraction and a force generated by the expansion and contraction causes a warp of the liquid crystal cell stuck on the polarizing plate, thereby generating display unevenness (light leak occurred at four corners of the liquid crystal cell) in the liquid crystal display device. With the reduction in thickness of various members in recent years, the light leakage resulting from the warp of the liquid crystal cell has become evident.

From the standpoint of transparency and securement of adhesion property to PVA used in the polarizer, although a protective film for polarizing plate of cellulose acylate has been widely employed because the adhesion property to PVA used in the polarizer can be easily secured, use of a protective film for polarizing plate made from an acrylic resin has been actively studied in recent years. Since an acrylic film made from the acrylic resin has a low water content ratio in comparison with a cellulose acylate film, it is expected to reduce the expansion and contraction of polarizing plate based on the coming and going of water (changes in humidity). A protective film for polarizing plate made from an acrylic resin and a cellulose ester resin is disclosed in WO 2009/047924.

### SUMMARY OF THE INVENTION

However, it has been found that the water content ratio is still high and the expansion and contraction of polarizing plate is large in the protective film for polarizing plate made from an acrylic resin and a cellulose ester resin described in WO 2009/047924.

The inventors have found that the force generated by the expansion and contraction of polarizing plate is determined by a product of a thickness, a modulus of elongation and a rate of dimensional change of a film and a polarizer constituting the polarizing plate, and the expansion and contraction of polarizing plate can be effectively restrained by designing a product of a thickness, a modulus of elongation and a rate of dimensional change of an optical film constituting the polarizing plate. The modulus of elongation and the rate of dimensional change are in a conflicting relation to each other, and when the modulus of elongation increases, the rate of dimensional change decreases.

Decrease in the modulus of elongation acts in the direction of reducing an expansion and contraction force of an optical film.

Although an optical film constituted by a cycloolefin resin as a polymer having a low modulus of elongation is exemplified, since a water content ratio of the optical film is extremely low, water cannot be completely removed from PVA in the production of polarizing plate and a state in which the polarizing plate is steamed and roasted is formed in a drying step (drying temperature of 60 to 80° C.) of the polarizing plate to cause degradation of PVA.

It is also found that a water content ratio of a film constituted only by an acrylic resin is approximately 1% (at 25° C. and relative humidity of 60%) and the film has the water content ratio to such an extent that the degradation of PVA can be prevented, but the modulus of elongation is higher than that of the cycloolefin resin and the expansion and contraction force of optical film cannot be sufficiently restrained.

In the film-forming step of optical film, since the film is transported while applying a tension of approximately 20 kg/m², stretching of the film occurs (draw ratio being approximately 10%). When the stretching of the film occurs, molecular orientation of acrylic resin is accelerated to generate changes in a retardation value, thereby being difficult to realize stable optical properties. Particularly, in an optical film having a low elastic modulus, the changes in a retardation value in the film-forming step notably occur.

A problem that the invention is to solve is to provide an optical film capable of solving a problem of light leakage based on the warp of liquid crystal cell, which occurs by lighting after storage under high humidity environment.

As a result of investigations, the inventors have found that an optical film made from an acrylic resin in which at least one of a modulus of elongation on a machine direction (MD direction) and a modulus of elongation on a direction vertical to the machine direction (TD direction) is less than 2.3×10⁹ N/m² and a variation amount of film in-plane retardation value Re when the film is stretched 10% satisfies a specific range can remarkably reduce the warp of liquid crystal cell and as a result, the light leakage can be significantly improved to complete the invention.

Specifically, the problems described above can be solved by the means described below.

(1) An optical film which is made from an acrylic resin, in which at least one of a modulus of elongation on a machine direction (MD direction) and a modulus of elongation on a direction vertical to the machine direction (TD direction) is less than 2.3×10⁹ N/m² and a film in-plane retardation value Re (nm) represented by formula (i) shown below satisfies formula (ia) shown below:

Re=(nx−ny)×d Formula (i)

ΔRe=Re(10)−Re(0)≦10 Formula (ia)

In the formulae, nx represents a refractive index in a film in-plane slow axis direction, ny represents a refractive index in a film in-plane fast axis direction, d represents a thickness (nm) of film, Re(10) represents a retardation value when the optical film is stretched 10%, and Re(0) represents a retardation value in an unstretched state.

(2) The optical film as described in (1), which contains an elastic modulus reducing agent which satisfies formula (1) shown below:

(E(A)−E(0))/A≦−0.01(×10⁹ N/m²% by weight) Formula (1)

In formula (1), A represents a content ratio (% by weight) of the elastic modulus reducing agent in the optical film, E(A) represents a modulus of elongation of the optical film containing A % by weight of the elastic modulus reducing agent, and E(0) represents a modulus of elongation of the optical film not containing the elastic modulus reducing agent.

(3) The optical film as described in (1), wherein the acrylic resin has a repeating unit derived from an elastic modulus reducing monomer which satisfies formula (2) shown below:

(E2(A2)−E2(0))/A2≦−0.01(×10⁹ N/m²% by weight) Formula (2)

In formula (2), A2 represents a content ratio (% by weight) of the repeating unit derived from an elastic modulus reducing monomer in the acrylic resin, E2(A2) represents a modulus of elongation of the optical film containing A2% by weight of the repeating unit derived from an elastic modulus reducing monomer in the acrylic resin, and E2(0) represents a modulus of elongation of the optical film not containing the repeating unit derived from an elastic modulus reducing monomer in the acrylic resin.

(4) The optical film as described in (2), which satisfies formula (3) shown below:

Tg(C)−Tg(D)≧−5(° C.) Formula (3)

In formula (3), Tg(C) represents a glass transition temperature of the optical film containing the elastic modulus reducing agent, and Tg(D) represents a glass transition temperature of the optical film not containing the elastic modulus reducing agent.

(5) The optical film as described in (2) or (4), wherein the elastic modulus reducing agent is a rubber polymer.
(6) The optical film as described in (2), wherein the elastic modulus reducing agent is a compound compatible with the acrylic resin.
(7) The optical film as described in (3), wherein the elastic modulus reducing monomer is an acrylate having a glass transition temperature of 25° C. or less.
(8) The optical film as described in any one of (1) to (7), wherein the acrylic resin is a polymer containing a lactone ring structure in a main chain or a polymer containing a glutarimide ring structure in a main chain.
(9) The optical film as described in any one of (1) to (8), wherein a film in-plane retardation value Re (nm) represented by formula (i) shown below and a film thickness direction retardation value Rth (nm) represented by formula (ii) shown below satisfy formulae (iii) and (iv) shown below:

Re=(nx−ny)×d Formula (i)

Rth=((nx+ny)/2−nz)×d Formula (ii)

0≦Re<20 nm Formula (iii)

|Rth|≦25 nm Formula (iv)

In the formulae, nx represents a refractive index in a film in-plane slow axis direction, ny represents a refractive index in a film in-plane fast axis direction, nz represents a refractive index in a film thickness direction, and d represents a thickness (nm) of film.

(10) The optical film as described in any one of (1) to (9), wherein at least one layer of a pattern retardation layer, a λ/4 layer, an optically anisotropic layer, a hardcoat layer, an antiglare layer, an antireflective layer, an antistatic layer and an easy adhesion layer is provided on a surface of the optical film.
(11) A polarizing plate having a polarizer and the optical film as described in any one of (1) to (10) provided at at least one side of the polarizer.
(12) The polarizing plate as described in (11), wherein the optical film as described in any one of (1) to (10) is provided at both sides of the polarizer.
(13) A liquid crystal display device having at least one sheet of the polarizing plate as described in (11) or (12).

According to the invention, a liquid crystal display device which solves a problem of light leakage based on the warp of liquid crystal cell, which occurs by lighting after storage under high humidity environment can be provided.

### DETAILED DESCRIPTION OF THE INVENTION

The optical film according to the invention is made from an acrylic resin.

The acrylic resin is a concept including a methacrylic resin, and also includes an acrylate/methacrylate derivative, particularly an acrylate/methacrylate (co)polymer.

Further, the acrylic resin includes an acrylic resin having a ring structure in the main chain including a polymer containing a lactone ring, a polymer containing a glutaric anhydride ring and a polymer containing a glutarimide ring, as well as the methacrylic resin.

The term “made from an acrylic resin” as used herein means that the acrylic resin is contained 50% by weight or more in the optical film. The optical film preferably contains 60% by weight or more of the acrylic resin, and more preferably contains 70% by weight or more of the acrylic resin.

### (Acrylic Resin)

A repeating structural unit of the acrylic resin is not particularly limited. The acrylic resin preferably contains a repeating structural unit derived from an acrylate monomer as the repeating structural unit.

The acrylate is not particularly limited and includes, for instance, an acrylate, for example, methyl acrylate, ethyl acrylate, n-butyl acrylate, isobutyl acrylate, tert-butyl acrylate, cyclohexyl acrylate or benzyl acrylate; and a methacrylate, for example, methyl methacrylate, ethyl methacrylate, propyl methacrylate, n-butyl methacrylate, isobutyl methacrylate, tert-butyl methacrylate, cyclohexyl methacrylate or benzyl methacrylate. The acrylates may be used individually or in combination of two or more thereof. Of the acrylates, methyl methacrylate is preferred because it is excellent in heat resistance and transparency.

In the case of using the acrylate as the main component, in view of exerting the effect of the invention sufficiently, the content ratio of the acrylate in the monomer component served for a polymerization step is preferably from 50 to 100% by weight, more preferably from 70 to 100% by weight, still more preferably from 80 to 100% by weight, and particularly preferably from 90 to 100% by weight.

A glass transition temperature Tg of the resin containing the acrylate as the main component is preferably in a range from 80 to 120° C.

A weight average molecular weight of the resin containing the acrylate as the main component is preferably in a range from 50,000 to 500,000.

### <Acrylic Resin Having Ring Structure in Main Chain>

Of the acrylic resins, an acrylic resin having a ring structure in a main chain is preferred. Due to the introduction of ring structure into a main chain, rigidity of the main chain is increased, thereby improving heat resistance.

Of the acrylic resins having a ring structure in a main chain, any one of a polymer containing a lactone ring structure in a main chain, a polymer containing a glutaric anhydride ring structure in a main chain and a polymer containing a glutarimide ring structure in a main chain is preferred, and a polymer containing a lactone ring structure in a main chain or a polymer containing a glutarimide ring structure in a main chain is more preferred.

Hereinafter, the polymer having a ring structure in a main chain is described in order.

### (1) Acrylic Polymer Having Lactone Ring Structure in Main Chain

The acrylic polymer having a lactone ring structure in a main chain (hereinafter, also referred to as a lactone ring-containing polymer) is not particularly limited as long as it is an acrylic resin having a lactone ring in a main chain, and preferably has a lactone ring structure represented by formula (100) shown below.

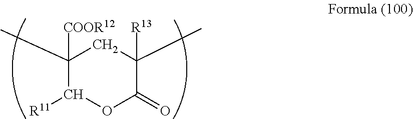

In formula (100), R¹¹, R¹² and R¹³ each independently represents a hydrogen atom or an organic residue having from 1 to 20 carbon atoms, and the organic residue may contain an oxygen atom.

The organic residue having from 1 to 20 carbon atoms is preferably an alkyl group having from 1 to 6 carbon atoms and specifically includes, for example, a methyl group, an ethyl group, an isopropyl group, an n-butyl group and a tert-butyl group.

A content ratio of the lactone ring structure represented by formula (100) contained in the structure of the lactone ring-containing polymer is preferably from 5 to 90% by weight, more preferably from 10 to 70% by weight, still more preferably from 10 to 60% by weight, and particularly preferably from 10 to 50% by weight. When the content ratio of the lactone ring structure is 5% by weight or more, heat resistance and surface hardness of the polymer obtained tend to be improved, and when the content ratio of the lactone ring structure is 90% by weight or less, a molding processability of the polymer obtained tends to be improved.

The content ratio of the lactone ring structure can be calculated according to the formula shown below.

Content ratio of lactone ring (% by weight)=B×A×M_{R}/Mₘ

In the formula, B represents a weight content ratio of a raw material monomer having a structure (hydroxy group) involved in lactone cyclization in a monomer composition used in the copolymerization, M_{R} represents a formula weight of a lactone ring structure unit generated, Mₘ represents a molecular weight of a raw material monomer having a structure (hydroxy group) involved in lactone ring formation, and A represents a lactone cyclization ratio.

The lactone cyclization ratio can be calculated, for example, in the case where the cyclization reaction is associated with a dealcoholization reaction, from a theoretical weight reduction amount and a weight reduction heat weight reduction ratio in the dealcoholization reaction from 150° C. before the weight starts to reduce to 300° C. before the polymer starts to decompose.

A production method of the acrylic resin having a lactone ring structure is not particularly limited. The acrylic resin having a lactone ring structure is preferably produced by obtaining a polymer (p) having a hydroxy group and an ester group in the molecular chain by polymerization of a prescribed monomer described below and then heat-treating the polymer (p) obtained in a temperature range from 75 to 120° C. to perform lactone cyclization condensation, thereby introducing a lactone ring structure into the polymer.

In the polymerization step, a polymer having a hydroxy group and an ester group in the molecular chain is obtained by performing a polymerization reaction of monomer component containing a monomer represented by formula (101) shown below.

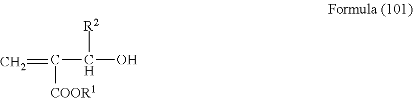

In formula (101), R¹ and R² each independently represents a hydrogen atom or an organic residue having from 1 to 20 carbon atoms.

Examples of the monomer represented by formula (101) include methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and tert-butyl 2-(hydroxymethyl)acrylate. Of the compounds, methyl 2-(hydroxymethyl)acrylate and ethyl 2-(hydroxymethyl)acrylate are preferred, and in view of a large effect of improvement in heat resistance, methyl 2-(hydroxymethyl)acrylate is particularly preferred. The monomers represented by formula (101) may be used individually or may be used in combination of two or more thereof.

A content ratio of the monomer represented by formula (101) in the monomer component served for the polymerization step has a lower limit value from the standpoint of heat resistance, solvent resistance and surface hardness and an upper limit value from the standpoint of molding processability of the polymer obtained, and taking into these points into consideration it is preferably from 5 to 90% by weight, more preferably from 10 to 70% by weight, still more preferably from 10 to 60% by weight, and particularly preferably from 10 to 50% by weight.

The monomer component served for the polymerization step may contain a monomer other than the monomer represented by formula (101). Such a monomer is not particularly limited, and preferably includes, for example, an acrylate, a monomer having a hydroxy group, an unsaturated carboxylic acid and a monomer represented by formula (102) shown below. The monomers other than the monomer represented by formula (101) may be used individually or may be used in combination of two or more thereof.

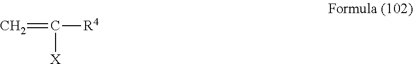

In formula (102), R⁴ represents a hydrogen atom or a methyl group, X represents a hydrogen atom, an alkyl group having from 1 to 20 carbon atoms, an aryl group, an —OAc group, a —CN group, a —CO—R⁵ group or an —CO—O—R⁶ group, Ac represents an acetyl group, and R⁵ and R⁶ each represents a hydrogen atom or an organic residue having from 1 to 20 carbon atoms.

A weight average molecular weight of the lactone ring-containing polymer is preferably from 10,000 to 2,000,000, more preferably from 20,000 to 1,000,000, and particularly preferably from 50,000 to 500,000.

In the lactone ring-containing polymer, a weight reduction ratio in a range from 150 to 300° C. in a dynamic TG measurement is preferably 1% or less, more preferably 0.5% or less, and still more preferably 0.3% or less. With respect to the method of dynamic TG measurement, the method described in JP-A-2002-138106 (the term “JP-A” as used herein means an “unexamined published Japanese patent application”) can be used.

Since the lactone ring-containing polymer has a high cyclization condensation reaction rate, a dealcoholization reaction less occurs in the production process of a molded article so that a defect, for example, formation of a bubble or a silver streak caused by the alcohol in the molded article after molding can be avoided. Further, due to the high cyclization condensation reaction rate, the lactone ring structure is sufficiently introduced into the polymer so that the lactone ring-containing polymer obtained has high heat resistance.

A coloration degree (YI) when forming a chloroform solution of the lactone ring-containing polymer in a concentration of 15% by weight is preferably 6 or less, more preferably 3 or less, still more preferably 2 or less, and particularly preferably 1 or less. When the coloration degree (YI) is 6 or less, a trouble, for example, impairment of transparency upon the coloration is hard to occur and the polymer can be preferably used in the invention.

A 5% weight reduction temperature of the lactone ring-containing polymer measured by a thermogravimetry (TG) is preferably 330° C. or more, more preferably 350° C. or more, and still more preferably 360° C. or more. The 5% weight reduction temperature measured by a thermogravimetry (TG) is an index of thermal stability and when it is 330° C. or more, sufficient thermal stability tends to be exerted. The thermogravimetry may be performed using an apparatus for the dynamic TG measurement described above.

A glass transition temperature (Tg) of the lactone ring-containing polymer is preferably from 115 to 180° C., more preferably from 120 to 170° C., and still more preferably from 125 to 160° C.

### (2) Polymer Having Glutaric Anhydride Ring Structure in Main Chain

The polymer having a glutaric anhydride ring structure in a main chain is a polymer having a glutaric anhydride unit.

The polymer having a glutaric anhydride unit preferably has a glutaric anhydride unit represented by formula (300) shown below (hereinafter, referred to as a “glutaric anhydride unit”).

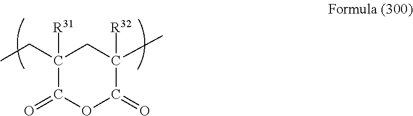

In formula (300), R³¹ and R³² each independently represents a hydrogen atom or an organic residue having from 1 to 20 carbon atoms, and the organic residue may contain an oxygen atom. In particular, R³¹ and R³², which may be the same or different, each preferably represents a hydrogen atom or an alkyl group having from 1 to 5 carbon atoms.

The polymer having a glutaric anhydride unit is preferably an acrylic resin containing a glutaric anhydride unit. The acrylic resin preferably has a glass transition temperature (Tg) of 120° C. or more from the standpoint of heat resistance.

A glass transition temperature (Tg) of the polymer having a glutaric anhydride ring structure in a main chain is preferably from 110 to 160° C., more preferably from 115 to 160° C., and still more preferably from 120 to 160° C.

A weight average molecular weight of the polymer having a glutaric anhydride ring structure in a main chain is preferably in a range from 50,000 to 500,000.

A content of the glutaric anhydride unit is preferably from 5 to 50% by weight, more preferably from 10 to 45% by weight with respect to the acrylic resin. When the content is 5% by weight or more, preferably 10% by weight or more, an effect of improving heat resistance can be obtained and further, an effect of improving weather resistance can also be obtained.

### (3) Acrylic Resin Having Glutarimide Ring Structure in Main Chain

The acrylic resin having a glutarimide ring structure in a main chain (hereinafter, also referred to as a glutarimide resin) exhibits a preferred characteristic balance in view of optical properties, heat resistance or the like because it has the glutarimide ring structure in a main chain. The acrylic resin having a glutarimide ring structure in a main chain is preferably a glutarimide resin having 20% by weight or more of a glutarimide unit represented by formula (400) shown below (wherein R³⁰¹, R³⁰² and R³⁰³ each independently represents a hydrogen atom, an unsubstituted or substituted alkyl group having from 1 to 12 carbon atoms, a cycloalkyl group or an aryl group).

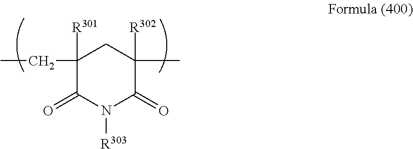

In a preferred glutarimide unit constituting the glutarimide resin for use in the invention, each of R³⁰¹ and R³⁰² is a hydrogen atom or a methyl group, and R³⁰³ is a methyl group or a cyclohexyl group. The glutarimide unit may be one kind or may contain plural kinds in which any of R³⁰¹, R³⁰² and R³⁰³ is different.

A preferred second constituting unit constituting the glutarimide resin for use in the invention is a unit made from an acrylate or methacrylate. Examples of preferred acrylate or methacrylate constituting unit include methyl acrylate, ethyl acrylate, methyl methacrylate and ethyl methacrylate. As other preferred unit capable of being imidized, an N-alkylmethacrylamide, for example, N-methylmethacrylamide or N-ethylmethacrylamide. The second constituting unit may be one kind or may contain plural kinds.

A content of the glutarimide unit represented by formula (400) in the glutarimide resin is preferably from 20 to 95% by weight, more preferably from 50 to 90% by weight, still more preferably from 60 to 80% by weight, based on the total repeating units of the glutarimide resin. The content of the glutarimide unit of 20% by weight or more is preferred from the standpoint of securing heat resistance and transparency of film obtained. The content of the glutarimide unit of 95% by weight or less is preferred from the standpoint of brittleness and transparency of film and film formation.

In the glutarimide resin, a third constituting unit may further be copolymerized, if desired. As the preferred third constituting unit, a constituting unit formed by copolymerization of a styrene monomer, for example, styrene, a substituted styrene or α-methylstyrene, an acrylic monomer, for example, butyl acrylate, a nitrile monomer, for example, acrylonitrile or methacrylonitrile, or a maleimide monomer, for example, maleimide, N-methylmaleimide, N-phenylmaleimide or N-cyclohexylmaleimide is used. The third constituting unit may be directly copolymerized with the glutarimide unit and the unit capable of being imidized or may be graft-copolymerized with a resin having the glutarimide unit and the unit capable of being imidized. In the case of adding the third component, the content ratio thereof in the glutarimide resin is preferably from 5 to 30% by weight based on the total repeating units of the glutarimide resin.

The glutarimide resin is described, for example, in U.S. Pat. Nos. 3,284,425 and 4,246,374 and JP-A-2-153904, and can be obtained by using as a resin having a unit capable of being imidized, a resin obtained from methyl methacrylate or the like as a main raw material and being imidized the resin having a unit capable of being imidized with ammonia or a substituted amine. In the production of glutarimide resin, a unit constituted from acrylic acid, methacrylic acid or anhydride thereof may be introduced into the glutarimide resin as a reaction by-product in some cases. The presence of the constituting component, particularly an acid anhydride, is not preferred because it causes decrease in total light transmittance or haze of the film according to the invention obtained. The content of acrylic acid or methacrylic acid is desirably controlled 0.5 milliequivalent or less, preferably 0.3 milliequivalent or less, more preferably 0.1 milliequivalent or less, per 1 g of the resin. It is also possible to obtain the glutarimide resin by conducting imidization using a resin mainly made from N-methylacrylamide and methyl methacrylate as described in JP-A-2-153904.

A glass transition temperature (Tg) of the glutarimide resin is preferably from 110 to 160° C., more preferably from 115 to 160° C., and still more preferably from 120 to 160° C.

A weight average molecular weight of the glutarimide resin is preferably in a range from 50,000 to 500,000.

### (4) Maleic Anhydride Polymer Having Succinic Anhydride Ring in Main Chain

The acrylic resin according to the invention may contain a maleic anhydride polymer having a succinic anhydride ring in a main chain as long as in a range of content ratio which satisfies the condition of optical properties of the optical film according to the invention.

By forming a succinic anhydride structure in a main molecular chain (main backbone of polymer), high heat resistance is imparted to the acrylic resin which is a copolymer and also a glass transition temperature (Tg) of the resin can be raised.

A glass transition temperature (Tg) of the maleic anhydride polymer having a succinic anhydride ring in a main chain is preferably from 110 to 160° C., more preferably from 115 to 160° C., and still more preferably from 120 to 160° C.

A weight average molecular weight of the maleic anhydride polymer having a succinic anhydride ring in a main chain is preferably in a range from 50,000 to 500,000.

The maleic anhydride unit for use in copolymerization with the acrylic resin is not particularly limited and includes maleic acid-modified resins described in JP-A-2008-216586, JP-A-2009-52021, JP-A-2009-196151 and JP-T-2012-504783 (the term “JP-T” as used herein means a published Japanese translation of a PCT patent application).

The invention should not be construed as being limited thereto.

A method for producing the acrylic resin containing a maleic anhydride unit is not particularly limited, and known methods can be used.

The maleic acid-modified resin is not particularly limited as long as a polymer obtained contains a maleic anhydride unit, and includes, for example, a maleic acid or anhydride modified MS resin, a maleic acid or anhydride modified MAS resin (methyl methacrylate-acrylonitrile-styrene copolymer), a maleic acid or anhydride modified MBS resin, a maleic acid or anhydride modified AS resin, a maleic acid or anhydride modified AA resin, a maleic acid or anhydride modified ABS resin, an ethylene-maleic anhydride copolymer, an ethylene-acrylic acid-maleic anhydride copolymer and a maleic anhydride graft polypropylene.

The malic anhydride unit has a structure represented by formula (200) shown below.

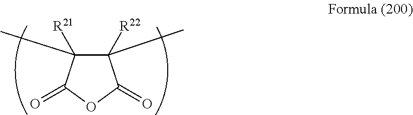

In formula (200), R²¹ and R²² each independently represents a hydrogen atom or an organic residue having from 1 to 20 carbon atoms.

The organic residue is not particularly limited as long as a number of carbon atoms included is in a range from 1 to 20, and includes, for example, a straight-chain or branched alkyl group, a straight-chain or branched alkylene group, an aryl group, a —OAc group and —CN group. The organic residue may contain an oxygen atom. Ac represents an acetyl group.

The number of carbon atoms included in R²¹ or R²² is preferably from 1 to 10, and more preferably from 1 to 5.

In the case where R²¹ and R²² each represents a hydrogen atom, it is also preferred that the acrylic resin further contains other copolymerization component in view of adjustment of an intrinsic birefringence. As such a ternary or higher heat-resistant acrylic resin, for example, a methyl methacrylate-maleic anhydride-styrene copolymer is preferably used.

In the optical film according to the invention, other resin may be used by mixing with the acrylic resin. A weight ratio of the acrylic resin and other resin is preferably from 96:4 to 100:0, more preferably from 97:3 to 100:0, still more preferably from 98:2 to 100:0, and most preferably 100:0. It is preferred that the weight ratio of the acrylic resin and other resin is in the range from 96:4 to 100:0, because the moisture permeability is low so that humidity expansion of polarizer due to water passed through the film can be more inhibited.

### <Modulus of Elongation>

In the optical film according to the invention, at least one of a modulus of elongation on a machine direction (MD direction) and a modulus of elongation on a direction vertical to the machine direction (TD direction) is less than 2.3×10⁹ N/m².

In the optical film according to the invention, at least one of a modulus of elongation on a MD direction and a modulus of elongation on a TD direction is preferably from 1.5×10⁹ N/m² to less than 2.0×10⁹ N/m², and more preferably both of the modulus of elongations are from 1.5×10⁹ N/m² to less than 2.0×10⁹ N/m².

By decreasing at least one of the modulus of elongation on a MD direction and the modulus of elongation on a TD direction of the optical film to less than 2.3×10⁹ N/m², a force generated by contraction of the polarizing plate can be weakened to make it possible to reduce the warp of liquid crystal cell. In the case of using an acrylic film in which at least one of the modulus of elongation on a MD direction and the modulus of elongation on a TD direction is less than 2.3×10⁹ N/m², the display unevenness generated based on the warp of liquid crystal cell can be definitely reduced in comparison with a case of using an ordinary acrylic film (having a modulus of elongation of about 3×10⁹ N/m²). Also, by setting the modulus of elongation to 1.5×10⁹ N/m² or more, a film having no problem of handling is formed and a sufficient hardness is achieved even when it is used on the outside (far side of the liquid crystal cell with respect to the polarizer) of polarizing plate.

The optical film according to the invention preferably contains the acrylic resin and an elastic modulus reducing agent which satisfies formula (1) shown below.

(E(A)−E(0))/A≦−0.01(×10⁹ N/m²% by weight) Formula (1)

In formula (1), A represents a content ratio (% by weight) of the elastic modulus reducing agent in the optical film, E(A) represents a modulus of elongation of the optical film containing A % by weight of the elastic modulus reducing agent, and E(0) represents a modulus of elongation of the optical film not containing the elastic modulus reducing agent.

The (E(A)−E(0))/A in formula (1) is also referred to as “ΔE(A)”.

In the optical film according to the invention, the ΔE(A) is preferably −0.015 or more, and more preferably −0.02 or more.

Whether the optical film satisfies formula (1) or not can be confirmed, for example, from a difference of the modulus of elongation between a film formed by adding the elastic modulus reducing agent to polymethyl methacrylate (having a weight average molecular weight approximately from 50,000 to 500,000) or by introducing a repeating unit derived from the elastic modulus reducing monomer into the acrylic resin and a film only composed of the polymethyl methacrylate.

### [Elastic Modulus Reducing Agent]

The elastic modulus reducing agent is a compound which can reduce the modulus of elongation of a film obtained to satisfy formula (1) by adding to the acrylic resin.

The optical film containing the elastic modulus reducing agent which satisfies formula (1) is preferably satisfies formula (3) shown below.

Tg(C)−Tg(D)≧−5(° C.) Formula (3)

In formula (3), Tg(C) represents a glass transition temperature of the optical film containing the elastic modulus reducing agent, and Tg(D) represents a glass transition temperature of the optical film not containing the elastic modulus reducing agent.

In order to form the optical film which satisfies formula (3), as the elastic modulus reducing agent, a resin incompatible with the acrylic resin or a compound compatible with the acrylic resin is preferred.

(Resin Incompatible with Acrylic Resin)

In the invention, the term “incompatible” means that when a melting temperature Tm or a glass transition point Tg of a molten mixture of two or more kinds of resins is measured and observed, a single peak of each resin constituting the molten mixture is observed. Also, it means that each phase is substantially observed by the observation with transmission electron microscope.

The resin incompatible with the acrylic resin, which is the elastic modulus reducing agent, is more preferably a rubber polymer. Specifically, the elastic modulus reducing agent is more preferably a rubber polymer.

The value of Tg(C)−Tg(D) is more preferably −3(° C.) or more, and still more preferably 0(° C.) or more.

By adding the rubber polymer to the optical film according to the invention, flexible property of the rubber polymer is imparted to the optical film to also improve brittleness.

### [Rubber Polymer]

As the rubber polymer, commercially available product, for example, acrylic modifier Kane Ace M210 produced by Kaneka Corp. (rubber particles having multilayer structure, core: multilayer acrylic rubber, shell: acrylic polymer containing methyl methacrylate as main component, approximate particle diameter: 220 nm) or an acrylic ABA type triblock copolymer (LA Polymer 4285, 2140E or 2250, produced by Kuraray Co., Ltd.) can be used.

In the optical film according to the invention, the rubber polymer is incorporated into the optical film preferably in an amount from 10 to less than 50% by weight, more preferably from 15 to 45% by weight, and still more preferably from 20 to 40% by weight.

### (Compatible Compound)

The optical film according to the invention also preferably contains a compound compatible with the acrylic resin as the elastic modulus reducing agent.

The term “compatible” means that when a melting temperature Tm or a glass transition point Tg of a molten mixture of the same kinds or two or more kinds of resins is measured and observed, one or more peaks of the molten mixture is observed. The Tg and Tm of the resin are temperatures at which baselines of Tg and Tm in DSC measurement begin to deflect.

The compound compatible with the acrylic resin includes a low molecular weight compound or oligomer having a molecular weight approximately from 190 to 5,000 and, for example, a phosphate, a carboxylate or a polyol ester is preferred. Specifically, as the elastic modulus reducing agent, a phosphate, a carboxylate and a polyol ester are also preferred.

Examples of the phosphate include triphenyl phosphate (TPP), tricresyl phosphate, cresyl diphenyl phosphate, octyl diphenyl phosphate, biphenyl diphenyl phosphate, trioctyl phosphate and tributyl phosphate. Triphenyl phosphate or biphenyl diphenyl phosphate is preferred.

The carboxylate typically includes a phthalate and a citrate. Examples of the phthalate include dimethyl phthalate, diethyl phthalate, dibutyl phthalate, dioctyl phthalate, diphenyl phthalate and diethyl hexyl phthalate. Examples of the citrate include triethyl O-acetylcitrate, tributyl O-acetylcitrate, acetyl triethyl citrate and acetyl tributyl citrate.

The preferred compound is liquid at 25° C. except for TPP (having a melting point of about 50° C.) and have a boiling point of 250° C. or higher.

Examples of the other carboxylate include butyl oleate, methyl acetyl ricinoleate, dibutyl sebacate and various trimellitates. Examples of the glycolate include triacetin, tributyrin, butyl phthalylbutyl glycolate, ethyl phthalylethyl glycolate, methyl phthalylethyl glycolate, butyl phthalylbutyl glycolate, methyl phthalylmethyl glycolate, propyl phthalylpropyl glycolate, butyl phthalylbutyl glycolate and octyl phthalyloctyl glycolate.

Also, plasticizers described, for example, in JP-A-5-194788, JP-A-60-250053, JP-A-4-227941, JP-A-6-16869, JP-A-5-271471, JP-A-7-286068, JP-A-5-5047, JP-A-11-80381, JP-A-7-20317, JP-A-8-57879, JP-A-10-152568, JP-A-10-120824 are preferably used as the compound compatible with the acrylic resin. In these patent publications, there are not only examples of the plasticizers but also many preferred descriptions on the methods of using them and the characteristics thereof, and these descriptions may be preferably used in the invention.

As other plasticizers, for example, (di)pentaerythritol esters described in JP-A-11-124445, glycerol esters described in JP-A-11-246704, diglycerol esters described in JP-A-2000-63560, citrates described in JP-A-11-92574, substituted phenyl phosphates described in JP-A-11-90946, and ester compounds containing an aromatic ring and a cyclohexane ring described in JP-A-2003-165868 are preferably used.

A polymer plasticizer containing a resin component having a molecular weight from 1,000 to 100,000 is also preferably used as the compound compatible with the acrylic resin. Examples thereof include polyesters and polyethers described in JP-A-2002-22956, polyester ethers, polyester urethanes or polyesters described in JP-A-5-197073, copolyester ethers described in JP-A-2-292342, and epoxy resins or novolak resins described in JP-A-2002-146044.

As the plasticizer excellent in view of vaporization resistance, bleeding out, low haze or the like, for example, polyester diols having hydroxy groups at both terminals thereof described in JP-A-2009-98674 are also preferably used. As the plasticizer excellent in view of planarity, low haze or the like of the optical film, sugar ester derivatives described in WO 2009/031464 are also preferred.

The compounds compatible with the acrylic resin may be used individually or in combination of two or more kinds thereof. An addition amount of the compound compatible with the acrylic resin is preferably from 2 to less than 50% by weight, more preferably from 2 to 40% by weight, still more preferably from 2 to 25% by weight, particularly preferably from 5 to 20% by weight, with respect to the acrylic resin.

It is also preferred that the optical film according to the invention is made from the acrylic resin having a repeating unit derived from an elastic modulus reducing monomer which satisfies formula (2) shown below.

(E2(A2)−E2(0))/A2≦−0.01(×10⁹ N/m²% by weight) Formula (2)

In formula (2), A2 represents a content ratio (% by weight) of the repeating unit derived from an elastic modulus reducing monomer in the acrylic resin, E2(A2) represents a modulus of elongation of the optical film containing A2% by weight of the repeating unit derived from an elastic modulus reducing monomer in the acrylic resin, and E2(0) represents a modulus of elongation of the optical film not containing the repeating unit derived from an elastic modulus reducing monomer in the acrylic resin.

The (E2(A2)−E2(0))/A2 in formula (2) is also referred to as “ΔE2(A2)”. In the optical film according to the invention, the ΔE2(A2) is preferably −0.015 or more, and more preferably −0.02 or more.

Whether the optical film satisfies formula (2) or not can be confirmed, for example, from a difference of the modulus of elongation between a film formed by adding the elastic modulus reducing agent to polymethyl methacrylate (having a weight average molecular weight approximately from 50,000 to 500,000) or by introducing a repeating unit derived from the elastic modulus reducing monomer into the acrylic resin and a film only composed of the polymethyl methacrylate.

### [Elastic Modulus Reducing Monomer]

The elastic modulus reducing monomer is a monomer which can reduce the modulus of elongation of a film obtained to satisfy formula (2) by copolymerization with the acrylic resin to introduce a repeating unit derived from the monomer into the molecule.

### <Acrylate Having Glass Transition Temperature of 25° C. or Less>

The elastic modulus reducing monomer is preferably an acrylate having a glass transition temperature of 25° C. or less.

The acrylate is not particularly limited and includes, for example, an acrylate, for example, methyl acrylate, ethyl acrylate, n-butyl acrylate, isobutyl acrylate, tert-butyl acrylate, cyclohexyl acrylate or benzyl acrylate. The acrylates may be used individually or in combination of two or more thereof. Of the acrylates, n-butyl acrylate is preferred because it is excellent in heat resistance and transparency.

In the case of using the acrylate as the elastic modulus reducing monomer, in view of exerting the effect of the invention sufficiently, the content ratio of the acrylate in the monomer component served for a polymerization step is preferably from 5 to less than 50% by weight, more preferably from 7.5 to 45% by weight, and still more preferably from 10 to 40% by weight.

### <Method for Producing Optical Film>

Hereinafter, a production method for performing film formation from a thermoplastic resin containing the acrylic resin is described in detail.

For film formation of the optical film using the acrylic resin, raw materials of film are blended by a conventionally known mixer, for example, an omni mixer, and then the resulting mixture is extrusion-kneaded. In this case, the kneader used for the extrusion kneading is not particularly limited, and a conventionally known kneader, for instance, an extruder, for example, a single screw extruder or a twin screw extruder, or a pressure kneader can be used.

As to the film forming method, a conventionally known film forming method, for example, a solution cast method (solution casting method), a melt extrusion method, a calendaring method or a compression molding method is exemplified. Of the film forming methods, a melt extrusion method is particularly preferred.

The melt extrusion method includes, for example, a T-die method and an inflation method. The film forming temperature therefor is not particularly limited and may be appropriately adjusted depending on a glass transition temperature of the raw material of film. For example, it is preferably from 150 to 350° C., and more preferably from 200 to 300° C.

In the case where the film formation is performed by the T-die method, a T-die is attached to a tip end of a known single screw extruder or twin screw extruder, and a film extruded in a film shape is rolled up to obtain a film in a roll shape. At this time, by applying stretching force to the film in the extrusion direction while appropriately adjusting a temperature of a roll-up roll, the film may also be uniaxially stretched. Further, by stretching the film in a direction vertical to the extrusion direction, simultaneous biaxial stretching, sequential biaxial stretching or the like may also be performed.

The optical film according to the invention is preferably a stretched film made from the acrylic resin. The stretched film may be any of a uniaxially stretched film and a biaxially stretched film. The biaxially stretched film may be any of a simultaneously biaxially stretched film and a sequentially biaxially stretched film. In the case of performing the biaxial stretching, the mechanical strength of the film increases to improve the film property.

A thickness of the optical film made from the acrylic resin is preferably from 5 to 80 μm, and more preferably from 10 to 40 μm. The thickness of 5 μm or more is preferred in view of increase in the film strength and durability (inhibition of crimp). The thickness of 80 μm or less is preferred in view of securement of transparency of film and securement of appropriate moisture permeability.

### [Glass Transition Temperature Tg]

A glass transition temperature Tg of the optical film according to the invention is preferably from 100 to 200° C., more preferably from 100 to 150° C., from the standpoint of production aptitude and heat resistance.

The glass transition temperature can be obtained as an average value of a temperature at which a baseline begins to change due to glass transition of the film and a temperature returning to the baseline when measured at a temperature rise rate of 10° C./minute using a differential scanning calorimeter (DSC).

The measurement of the glass transition temperature can also be performed using a dynamic viscoelasticity measuring device as described below. A 5 mm×30 mm film sample (unstretched) according to the invention is subjected to humidity conditioning at 25° C. and 60% RH for 2 hours or more and then measured by a dynamic viscoelasticity measuring device (VIBRON DVA-225, produced by IT Keisoku Seigyo K.K.) under the conditions of a grip-to-grip distance of 20 mm, a temperature rise rate of 2° C./minute, a measuring temperature range from 30 to 250° C. and a frequency of 1 Hz. When the storage elastic modules is taken as a logarithmic axis on the vertical axis and the temperature (° C.) is taken as a linear axis on the horizontal axis and when a drastic decrease in the storage elastic modules which is observed in the process where the storage elastic modules moves from a solid region to a glass transition region is drawn as line 1 in the solid region and drawn as line 2 in the glass transition region, an intersection point of lines 1 and 2 corresponds to the temperature at which the storage elastic modules drastically decreases upon increasing temperature and the film initiates to soften and at which the film initiates to move to the glass transition region. Thus, the temperature is taken as the glass transition temperature Tg (dynamic viscoelasticity).

In the invention, Tg is determined using the dynamic viscoelasticity measuring device.

In the optical film according to the invention, the film in-plane retardation value Re represented by Re=(nx−ny)×d preferably satisfies 0 nm≦Re<20 nm, more preferably 0 nm≦Re<15 nm, and still more 0 nm≦Re<10 nm

In the optical film according to the invention, the film thickness direction retardation value Rth represented by Rth=((nx+ny)/2−nz)×d preferably satisfies |Rth|≦25 nm. In the optical film according to the invention, the film thickness direction retardation value Rth represented by Rth=((nx+ny)/2−nz)×d preferably satisfies |Rth|≦25 nm, more preferably |Rth|≦20 nm, still more preferably |Rth|≦10 nm, and most preferably −10 nm≦Rth≦5 nm.

In the case where the optical film according to the invention is stretched 10%, ΔRe=Re(10)−Re(0), which is a difference of the film in-plane retardation values represented by Re=(nx−ny)×d, preferably satisfies 0 nm≦ΔRe≦10 nm, more preferably 0 nm≦ΔRe≦7 nm, and still more preferably 0 nm≦ΔRe≦5 nm

The term “stretched 10%” used in the invention means that an unstretched film (100%) is uniaxially stretched 110% in the TD direction at the glass transfer temperature and at a rate of 30%/minute.

By satisfying ΔRe≦10 nm when stretched 10% in the invention, the optical properties in the plane of the film become uniform, display properties as liquid crystal display device are excellent, and the film can be used without limitation in use.

In the specification, Re (λnm) and Rth (λnm) represent an in-plane retardation and thickness direction retardation at a wavelength λ (unit: nm), respectively. The Re (λnm) is measured by applying light having a wavelength λnm to a film in the normal direction of the film, using KOBRA 21ADH or WR (produced by Oji Scientific Instruments). The selection of the measurement wavelength λnm may be conducted according to manual exchange of wavelength selective filter or according to conversion of the measurement value by a program or the like. In the case where the film to be measured is expressed by a uniaxial or biaxial refractive index ellipsoid, Rth (λnm) of the film is calculated in the manner described below.

Six Re (λnm) values are measured for incoming light of a wavelength λnm in six directions which are decided by a 10° step rotation from 0° to 50° with respect to the normal direction of film using an in-plane slow axis (which is decided by KOBRA 21ADH or WR), as an inclination axis (rotation axis) (in the case where the film has no slow axis, an arbitrary in-plane direction of film is defined as the rotation axis), and the Rth (λnm) is calculated by KOBRA 21ADH or WR on the basis of the six Re(λ) values measured, a value of hypothetical average refractive index, and a thickness value of the film entered.

In the above calculation, when there is no particular description on λ and only Re or Rth is described, the values represent those measured using light having a wavelength of 550 nm. Also, when the film has a retardation value of zero at a certain inclination angle to the normal direction using the in-plane slow axis as the rotation axis, a retardation value at the inclination angle larger than the inclination angle to give a zero retardation is changed to a negative sign, and then the Rth(λ) of the film is calculated by KOBRA 21ADH or WR.

Further, using the slow axis as the inclination axis (rotation axis) (in the case where the film has no slow axis, an arbitrary in-plane direction is defined as the rotation axis), the retardation values are measured in arbitrary inclined two directions, and based on the data, a value of hypothetical average refractive index, and a thickness value of the film entered, Rth can also be calculated according to formulae (4) and (5) shown below.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 4 )$$

Rth=((nx+ny)/2−nz)×d Formula (5)

In the formulae above, Re(θ) represents a retardation value in the direction inclined by an angle θ from the normal direction, nx represents a refractive index in the in-plane slow axis direction, ny represents a refractive index in the direction perpendicular to nx in the plane, nz represents a refractive index in the direction perpendicular to nx and ny, and d represents a thickness of film.

In the above measurement, as the value of hypothetical average refractive index, values described in Polymer Handbook (JOHN WILEY & SONS, INC.) and catalogs of various optical films can be used. In the case where a value of average refractive index is unknown, the value can be measured by an Abbe refractometer. The average refractive indexes of major optical films are shown below: cellulose acylate (1.48), cycloolefin polymer (1.52), polycarbonate (1.59), polymethyl methacrylate (1.49), and polystyrene (1.59).

### <Polarizing Plate>

The polarizing plate according to the invention has a polarizer and the optical film according to the invention described above provided on at least one surface of the polarizer. The polarizing plate according to the invention preferably has the optical films according to the invention described above on both surfaces of the polarizer.

The polarizing plate according to the invention preferably has the polarizer and the optical film according to the invention described above as a protective film of the polarizer. The configuration of the polarizing plate is preferably protective film/polarizer/protective film, protective film/polarizer or protective film/polarizer/coating layer.

With respect to the polarizing plate protective film constituting the polarizing plate according to the invention, materials capable of using in the protective film other than the optical film according to the invention described above are not particularly limited. The protective film may be a layer or film (hereinafter, also collectively referred to as a “film”) made from various polymers. For instance, one kind or two or more kinds of polymers selected from a cellulose acylate polymer, a polycarbonate polymer, a polyester polymer, for example, polyethylene terephthalate or polyethylene naphthalate, an acrylic polymer, for example, polymethyl methacrylate, and a styrene polymer, for example, polystyrene or an acrylonitrile-styrene copolymer (AS resin) can be utilized. Also, one kind or two or more kinds of polymers selected from polyolefin, for example, polyethylene or polypropylene, a polyolefin polymer, for example, an ethylene-propylene copolymer, a cycloolefin polymer, a vinyl chloride polymer, an amide polymer, for example, nylon or an aromatic polyamide, an imide polymer, a sulfone polymer, a polyethersulfone polymer, a polyetheretherketone polymer, a polyphenylene sulfide polymer, a vinylidene chloride polymer, a vinyl alcohol polymer, a vinyl butyral polymer, an arylate polymer, a polyoxymethylene polymer, an epoxy polymer, and a mixture of the polymers described above may be used as the main component to form a polymer layer or film. Also, a layer formed by polymerizing a rod-like liquid crystal or discotic liquid crystal having a polymerizable group in a predetermined orientation state to fix may be used.

In the case where other optical film is stuck on a surface of the polarizer opposite to a surface on which the optical film according to the invention is stuck in the polarizing plate according to the invention, the other optical film may have a functional layer. In order to improve an adhesion property to the polarizer or other functional layer, an easy adhesion layer may be provided as the functional layer.

The polarizing plate according to the invention can be produced according to an ordinary method. For example, a method wherein a polarizer and the optical film according to the invention are stacked is used.

For the stacking, an adhesive is ordinarily used. An adhesive layer between a polarizer and polarizing plate protective films provided on both surfaces thereof has a thickness approximately from 0.01 to 30 μm. The thickness of the adhesive layer is preferably from 0.01 to 10 μm, and more preferably from 0.05 to 5 μm. When the thickness of the adhesive layer in in the range described above, space or peeling does not occur between the polarizing plate protective film and the polarizer stacked so that an adhesion force sufficient for practical use can be obtained.

As one preferred example of the adhesive, an aqueous adhesive, that is, in which an adhesive component is dissolved or dispersed in water is exemplified and an adhesive composed on aqueous solution of a polyvinyl alcohol resin is preferably used.

In the adhesive composed on aqueous solution of a polyvinyl alcohol resin, the polyvinyl alcohol resin includes as well as a homopolymer of vinyl alcohol obtained by saponification treatment of polyvinyl acetate which is a homopolymer of vinyl acetate, a polyvinyl alcohol copolymer obtained by saponification treatment of a copolymer of vinyl acetate and other monomer copolymerizable therewith and a modified polyvinyl alcohol polymer wherein the hydroxy groups thereof are partially modified.

To the adhesive, a polyvalent aldehyde, a water-soluble epoxy compound, a melamine compound, a zirconia compound, a zinc compound, a glyoxylate or the like may be added as a crosslinking agent. In the case of using the aqueous adhesive, a thickness of the adhesive layer formed therefrom is ordinarily 1 μm or less.

As another preferred example of the adhesive, a curable adhesive composition containing an epoxy compound curable by irradiation with an active energy ray or heating is exemplified. The curable epoxy compound has at least two epoxy groups in the molecule thereof. In this case, adhesion between a polarizer and a protective film can be performed by a method wherein a coating layer of the adhesive composition is exposed to an active energy ray or heated to cure the curable epoxy compound contained in the adhesive composition. The curing of epoxy compound is ordinarily performed by a cation polymerization of the epoxy compound. From the standpoint of productivity, it is preferred that the curing is performed by the irradiation of active energy ray.

In the case of using the curable adhesive, a thickness of the adhesive layer formed therefrom is ordinarily approximately from 0.5 to 5 μm.

In the case of using the curable adhesive, a film is stuck using a sticking roller, if desired, dried, and then exposed to an active energy ray or heated to cure the curable adhesive. A light source of the active energy ray is not particularly limited, and an active energy ray having a light emission distribution in a wavelength of 400 nm or less is preferred. Specifically, for example, a low-pressure mercury lamp, a middle-pressure mercury lamp, a high-pressure mercury lamp, a super high-pressure mercury lamp, a chemical lamp, a black light lamp, a microwave-excited mercury lamp or a metal halide lamp is preferably used.

From the standpoint of weather fastness, refractive index, cation polymerizability or the like, the epoxy compound contained in the curable adhesive composition is preferably that having no aromatic ring in the molecule thereof. Examples of the epoxy compound having no aromatic ring in the molecule thereof include a hydrogenated epoxy compound, an alicyclic epoxy compound and an aliphatic epoxy compound. The epoxy compound preferably used in the curable adhesive composition is described in detail, for example, in JP-A-2004-245925.

In the sticking of the optical film according to the invention and a polarizer with an adhesive, for the purpose of increasing an adhesion strength, a surface treatment (for example, glow discharge treatment, corona discharge treatment or ultraviolet ray (UV) treatment) may be performed or an easy adhesion layer or the like may be formed on a surface of the optical film according to the invention facing the polarizer. Materials, forming methods and the like of the easy adhesion layer described in JP-A-2007-127893 and JP-A-2007-127893 can be used.

In the case of using a film other than the optical film according to the invention as a protective film, for example, in an embodiment using a cellulose acylate film (cellulose acylate polymer layer), a rear surface of the cellulose acylate film and a polarizer are stuck to produce a polarizing plate. In an embodiment where an aqueous adhesive is used in the sticking of the cellulose acylate film and the polarizer, it is preferred that the sticking surface of the cellulose acylate film is subjected to an alkali saponification treatment. An aqueous solution of fully-saponified polyvinyl alcohol can be used for the sticking.

As the polarizer, those produced by a conventionally known method can be used, and a polyvinyl alcohol polarizer is preferred. For example, a film made from a hydrophilic polymer, for example, polyvinyl alcohol or ethylene-modified polyvinyl alcohol having an ethylene unit content from 1 to 4% by mole, a polymerization degree form 2,000 to 4,000 and a saponification degree from 99.0 to 99.99% by mole is treated with a dichroic dye, for example, iodine and stretched or a plastic film, for example, vinyl chloride, which is treated to be oriented is used.

Also, methods wherein a stacked film having a polyvinyl alcohol layer formed on a base material is subjected to stretching and dying to obtain a polarizer film having a thickness of 10 μm or less are described in Japanese Patent Nos. 5048120, 5143918, 5048120, 4691205, 4751481 and 4751486 are exemplified, and these known techniques relating to the polarizer can be preferably utilized in the polarizing plate according to the invention.

### <Functional Layer>

The optical film according to the invention may have a functional layer on at least one of the surfaces thereof. Examples of the functional layer include a pattern retardation layer for three-dimensional image display, a λ/4 layer, an optically anisotropic layer, a hardcoat layer, an antireflective layer, an antiglare layer, an antistatic layer and an easy adhesion layer. The functional layers may be used individually or in combination. In particular, in an embodiment where a pattern retardation layer or a λ/4 layer is provided on the optical film according to the invention, it is preferred to provide a hardcoat layer on the other surface of the optical film according to the invention or on the pattern retardation layer or λ/4 layer. Also, in the embodiment where the hardcoat layer is provided on the pattern retardation layer or λ/4 layer, it is preferred to impart an ultraviolet-absorbing ability to a layer disposed closer to the viewing side than the pattern retardation layer or λ/4 layer or the hardcoat layer.

In the case where the polarizing plate according to the invention has a configuration of protective film/polarizer/functional layer, specifically, a configuration in which the polarizer is sandwiched between the protective film, which is the optical film according to the invention, and the functional layer, according to an embodiment where the functional layer is disposed close to the liquid crystal cell in a liquid crystal display device, the functional layer is preferably a λ/4 layer, an optically anisotropic layer, a hardcoat layer, an antistatic layer or an easy adhesion layer.

### <Pattern Retardation Layer>

The pattern retardation layer comprises a first retardation region and a second retardation region in which at least one of an in-plane slow axis direction and an in-plane retardation is different from each other, the first retardation region and the second retardation region are alternately arranged in the plane, and a boundary portion is provided between the first retardation region and the second retardation region. One example is an optically anisotropic layer in which the first retardation region and the second retardation region have Re of approximately λ/4, respectively and the in-plane slow axes thereof are orthogonally crossed. Although there are various methods for forming the pattern retardation layer, it is preferred to form by polymerizing a rod-like liquid crystal having a polymerizable group in a horizontally oriented state and a discotic liquid crystal in a vertically oriented state to fix.

In general, the liquid crystal compounds are classified into a rod-like type and a discotic type based on the shape thereof. They include a low molecular type and a polymer type, respectively. The polymer type indicates that having a polymerization degree of 100 or more (Masao Doi, Kobunshi Butsuri•Soten-i Dynamics (Polymer Physics and Phase Transition Dynamics), page 2, Iwanami Shoten, Publishers (1992)). In the pattern optically anisotropic layer used in the invention, any liquid crystal compound can be used, and it is preferred to use a rod-like liquid crystal compound or a discotic liquid crystal compound. Two or more rod-like liquid crystal compounds, two or more discotic liquid crystal compounds or a mixture of a rod-like liquid crystal compound and a discotic liquid crystal compound may also be used. Since temperature change or humidity change can be reduced, it is more preferred to use a rod-like liquid crystal compound or discotic liquid crystal compound having a reactive group, and it is still more preferred that at least one contains two or more reactive groups per liquid crystal molecule. The liquid crystal compound may be a mixture of two or more kinds of the liquid crystal compounds, and in this case at least one of them preferably has two or more reactive groups.

As the rod-like liquid crystal compound, those described in JP-T-11-513019 and JP-A-2007-279688 are preferably used, and as the discotic liquid crystal compound, those described in JP-A-2007-108732 and JP-A-2010-244038 are preferably used, but the invention should not be construed as being limited thereto.

It is also preferred that the liquid crustal compound has two or more kinds of reactive groups having different polymerization conditions. In this case, by polymerizing only a part kind of the plural kind reactive groups by selecting the conditions, it is possible to produce a retardation layer containing a polymer having unreacted reactive group. Although the polymerization condition used may be a wavelength range of ionizing radiation used for the polymerization and fixation or a difference in the polymerization mechanism used, but a combination of a radical reactive group and a cationic reactive group, which can be controlled depending on the kind of initiator used, is preferred. A combination in which the radical reactive group is an acryl group and/or a methacryl group and the cationic reactive group is a vinyl ether group, an oxetane group and/or an epoxy group is particularly preferred because the reactivity is easily controlled.

The optically anisotropic layer can be formed by various methods utilizing an oriented film, and the method for producing thereof is not particularly limited.

A first embodiment is a method where a plurality of actions which affect orientation control of the liquid crystal are utilized, and then any of the actions is extinguished by an external stimulus (for example, heat treatment) to dominantly conduct the predetermined orientation control action. For instance, by a composite action of an orientation control ability due to the oriented film and an orientation control ability of an orientation control agent added to the liquid crystal compound, the predetermined orientation state of liquid crystal is formed and fixed to form one retardation region, and then by an external stimulus (for example, heat treatment), any of the actions (for example, the action by the orientation control agent) is distinguished to dominantly conduct the other orientation control action (for example, the action by the oriented film), thereby realizing other orientation state, followed by fixing to form the other retardation region. For example, a specific pyridinium compound or imidazolium compound is unevenly distributed in a surface of a hydrophilic polyvinyl alcohol oriented film because the pyridinium group or imidazolium group is hydrophilic. In particular, when the pyridinium group is further substituted with an amino group which is a substituent of an acceptor of a hydrogen atom, an intermolecular hydrogen bong is formed with polyvinyl alcohol to be unevenly distributed in the surface of oriented film in higher density, and due to the effect of hydrogen bond the pyridinium derivative is oriented in a direction orthogonally crossed with the main chain of polyvinyl alcohol to accelerate orthogonal orientation of the liquid crystal with respect to the rubbing direction. Since the pyridinium derivative has plural aromatic rings in the molecule, a strong intermolecular π-π interaction occurs between the pyridinium derivative and the liquid crystal, particularly, the discotic liquid crystal compound to induce the orthogonal orientation of the discotic liquid crystal in the vicinity of the interface of the oriented layer. In particular, in the case where the hydrophobic aromatic ring is connected to the hydrophilic pyridinium group, due to the hydrophobicity an effect of inducing a vertical orientation. However, when the oriented film is heated higher than a certain temperature, the hydrogen bond is cleaved and the density of the pyridinium compound in the surface of the oriented film decreases to disappear the actions. As a result, the liquid crystal is oriented by the regulatory power of rubbing oriented film itself to form a parallel orientation state of the liquid crystal. The details of the method are described in JP-A-2012-8170 and the contents thereof are incorporated herein by reference.

A second embodiment is an embodiment utilizing a pattern oriented film. According to the embodiment, pattern oriented films having orientation control abilities different from each other are formed, a liquid crystal compound is disposed on the pattern oriented films to orient the liquid crystal. The liquid crystal is subjected to the orientation control by the respective orientation control abilities of the pattern oriented films to achieve the orientation states different from each other. When the respective orientation states are fixed, the patterns of the first and second retardation regions are formed according to the patterns of the oriented films. The pattern oriented films can be formed, for example, by a printing method, mask-rubbing to a rubbing oriented film or mask exposure to a photo oriented film. In addition, the pattern oriented film can be formed by uniformly forming an oriented film, and separately printing an additive (for example, the onium salt described above) which affects the orientation control ability in a predetermined pattern. A method using the printing method is preferred from the standpoint that a large facility is not required and the production is easy. The details of the method are described in JP-A-2012-32661 and the contents thereof are incorporated herein by reference.

Further, the first embodiment and the second embodiment are used together. One example is that a photo acid generator is added to the oriented film. In the example, the photo acid generator is added to the oriented film, and the photo acid generator is decomposed by pattern exposure so as to form an area in which an acidic compound is generated and an area in which the acidic compound is not generated. In the unexposed area, the photo acid generator is almost not decomposed, the interaction between the oriented film material, the liquid crystal and an orientation control agent which is optionally added dominates the orientation state, and the liquid crystal is oriented in a direction in which the slow axis orthogonally crosses with the rubbing direction. When light is irradiated to the oriented film to generate an acidic compound, the interaction loses the dominancy, the rubbing direction of the rubbing oriented film dominates the orientation state, and the liquid crystal is oriented in parallel in which the slow axis is in parallel with the rubbing direction. As the photo acid generator for use in the oriented film, a water-soluble compound is preferably used. Examples of the photo acid generator usable include compounds described in Prog. Polym. Sci., vol. 23, page 1485 (1998). A pyridinium salt, an iodonium salt and a sulfonium salt are particularly preferably used as the photo acid generator. The details of the method are described in JP-A-2012-150428 and the contents thereof are incorporated herein by reference.

### (Formation of First Region and Second Region)

The optical film according to the invention has a first retardation region (hereinafter, also simply referred to as a first region) and a second retardation region (hereinafter, also simply referred to as a second region) in which birefringence is different from each other and an optically anisotropic layer (hereinafter, also referred to as a pattern retardation layer) in which the first retardation region and the second retardation region are alternately patterned for every one line. It is preferred that the first region and the second region have band-like shapes wherein the lengths of the short sides of the regions are almost equal to each other and are repetitively and alternately patterned from the standpoint of being used for a 3D stereoscopic image display system.

For the optical film according to the invention, it is preferred that the slow axis of the first region and the slow axis of the second region are approximately orthogonally crossed from the standpoint that the polarization state of light passed through the first region and the second region can be converted from the linearly polarized light to the circularly polarized light or from the circularly polarized light to the linearly polarized light, during the 3D image display.

Further, for the optical film according to the invention, it is more preferred that the slow axis of the first region and the slow axis of the second region are orthogonally crossed from the viewpoint that the polarization state of light passed through the first region and the second region can be converted from the linearly polarized light to the circularly polarized light or from the circularly polarized light to the linearly polarized light without being elliptically polarized, during the 3D image display.

For the optical film according to the invention, it is preferred that the direction of the long side of the pattern and the direction in which the sound velocity of the support becomes the maximum are approximately orthogonally crossed from the standpoint that the misalignment of the pattern region and the pixel can be reduced to suppress the crosstalk.

### (Retardation)

As described above, it is preferred that a pattern retardation layer having a function of converting the linearly polarized light to the circularly polarized light or the circularly polarized light to the linearly polarized light has a retardation of ¼ wavelength. The retardation layer is ordinarily called as a ¼ wavelength plate, and at a visible light wavelength of 550 nm, Re is 137.5 nm as the ideal value.

Further, a pattern retardation layer of converting the linearly polarized light to the circularly polarized light or the circularly polarized light to the linearly polarized light does not always have a retardation of ¼ wavelength. For example, the layer may have a retardation of −¼ or ¾ wavelength, and when the relationship is represented by a formula, the layer may have a retardation of ¼±n/2 (n is an integer) wavelength.

For the patterning in which the slow axis of the first region and the slow axis of the second region are orthogonally crossed, it is preferred that regions having retardations of −¼ and ¼ of wavelength may be alternately formed. At this time, the slow axes of the respective regions are approximately orthogonally crossed. Further, retardations of ¼ and ¾ wavelength may be patterned and at this time, the slow axes of the respective regions are approximately parallel to each other. However, the rotation directions of the circularly polarized light of the respective regions are opposite to each other.

Furthermore, for the patterning of the retardations of ¼ and ¾ wavelength, a retardation of ½ or −½ wavelength may be formed after a retardation of ¼ wavelength is formed on the entire surface.

When the optical film according to the invention has the retardation of ¼ wavelength, a Re (550) value of the first region included in the optical film and a Re (550) value of the second region included in the optical film are preferably from 30 nm to 250 nm, more preferably from 50 nm to 230 nm, particularly preferably from 100 nm to 200 nm, more particularly preferably from 105 nm to 180 nm, even more preferably from 115 nm to 160 nm, and more particularly preferably from 120 nm to 150 nm

Further, the entire Re (550) of the pattern retardation layer and the support is preferably from 110 nm to 165 nm, more preferably from 110 nm to 155 nm, and even more preferably from 120 nm to 145 nm from the standpoint that the polarization state of light passed through the first region and the second region can be converted from the linearly polarized light to the circularly polarized light or from the circularly polarized light to the linearly polarized light, during the 3D image display. In particular, it is preferred that the entire Re (550) of the pattern retardation layer and the support is within the range described above and the slow axes of the first regions and the second regions are approximately orthogonally crossed from the standpoint that the polarization state of an image for the right eye and an image for the left eye can be changed with accuracy.

### <λ/4 Layer>

The λ/4 layer is an embodiment wherein only the first retardation region described in the pattern retardation layer above is present. Specifically, it is not an embodiment having two regions in which birefringence is different from each other but an embodiment having a region of uniform birefringence. The preferred material and retardation range are same as those in the pattern retardation layer.

### <Optically Anisotropic Layer>

The optically anisotropic layer is a layer made from various polymers described above in a predetermined orientation state or a layer formed by polymerizing a rod-like liquid crystal or discotic liquid crystal having a polymerizable group in a predetermined orientation state to fix. As the rod-like liquid crystal or discotic liquid crystal having a polymerizable group, the material described in the pattern retardation layer can be used.

### <Hardcoat Layer>

The hardcoat layer for use in the invention is a layer for imparting hardness and scratch resistance to the film. For example, the hardcoat layer can be formed by coating a coating composition on the optical film according to the invention, which is a base material film, followed by curing. For the purpose of imparting other function to the film, other functional layer may be stacked on the hardcoat layer. A filler and an additive may be added to the hardcoat layer to impart mechanical, electrical or optical physical performance or chemical performance, for example, water repellency or oil repellency to the hard coat layer itself.

The hardcoat layer preferably has a thickness from 0.1 to 6 μm, and more preferably from 3 to 6 μm. By using such a thin hardcoat layer having the thickness in the range described above, the optical film including the hardcoat layer which achieves the improvement in physical property, for example, brittleness and curling prevention, weight saving and reduction of production cost can be obtained. Also, by using a base material film having a large modulus of elongation on the MD direction, specifically, a modulus of elongation more than the specific modulus of elongation described above, pencil hardness can be remarkably increased.

The hardcoat layer is preferably formed by curing a curable composition. The curable composition is preferably prepared as a liquid coating composition. One example of the coating composition contains a monomer or oligomer for matrix-forming binder, a polymer and an organic solvent. By curing the coating composition after coating, the hardcoat layer can be formed. For the curing, crosslinking reaction or polymerization reaction can be utilized.

### (Monomer or Oligomer for Matrix-Forming Binder)

Examples of the monomer or oligomer for matrix-forming binder usable in the invention include ionizing radiation-curable polyfunctional monomers and polyfunctional oligomers. The polyfunctional monomer or polyfunctional oligomer is preferably crosslinkable or polymerizable. The functional group in the ionizing radiation-curable polyfunctional monomer or polyfunctional oligomer is preferably a photo-, electron beam- or radiation-curable functional group and of the groups, a photopolymerizable functional group is more preferred.

The photopolymerizable functional group includes an unsaturated polymerizable functional group, for example, a (meth)acryloyl group, a vinyl group, a styryl group, an allyl group, and a ring-opening polymerization type polymerizable functional group, for example, those in epoxy compound. Of the groups, a (meth)acryloyl group is preferred.

Specific examples of the photopolymerizable polyfunctional monomer having a photopolymerizable functional group include a (meth)acrylic diester of alkylene glycol, for example, neopentyl glycol acrylate, 1,6-hexanediol (meth)acrylate or propylene glycol di(meth)acrylate; a (meth)acrylic diester of polyoxyalkylene glycol, for example, triethylene glycol di(meth)acrylate, dipropylene glycol di(meth)acrylate, polyethylene glycol di(meth)acrylate or polypropylene glycol di(meth)acrylate; a (meth)acrylic diester of polyhydric alcohol, for example, pentaerythritol di(meth)acrylate; and a (meth)acrylic diester of ethylene oxide or propylene oxide adduct, for example, 2,2-bis{4-(acryloxy diethoxy)phenyl}propane or 2,2-bis{4-(acryloxy polypropoxy)phenyl}propane.

Further, a urethane (meth)acrylate, a polyester (meth)acrylate, an isocyanuric acrylate or an epoxy (meth)acrylate is also preferably used as the photopolymerizable polyfunctional monomer.

Of the compounds described above, an ester of a polyhydric alcohol and (meth)acrylic acid is preferred, and a polyfunctional monomer having 3 or more (meth)acryloyl groups per molecule is more preferred.

Specifically, (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexaacrylate, trimethylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-cyclohexane tetramethacrylate, polyester polyacrylate, and caprolactone-modified tris(acryloxyethyl)isocyanurate are illustrated.

In the specification, “(meth)acrylate”, “(meth)acrylic acid” and “(meth) acryloyl” each mean “acrylate or methacrylate”, “acrylic acid or methacrylic acid” and “acryloyl or methacryloyl”, respectively.

Further, a resin having 3 or more (meth)acryloyl groups, for example, a polyester resin having a relatively low molecular weight, a polyether resin, an acrylic resin, an epoxy resin, a urethane resin, an alkyd resin, a spiroacetal resin, a polybutadiene resin, a polythiol polyene resin, and an oligomer or prepolymer of polyfunctional compound, for example, polyhydric alcohol are also exemplified.

As to specific compounds of polyfunctional acrylate compound having 3 or more (meth)acryloyl groups, the description in Paragraph No. [0096] of JP-A-2007-256844 can be referred to.

As an urethane acrylate, for example, a urethane acrylate compound obtained by reacting a hydroxy group-containing compound, for example, an alcohol, an polyol and/or a hydroxy group-containing acrylate with an isocyanate, and if desired, followed by esterifying the polyurethane compound obtained through the reaction with (meth)acrylic acid is exemplified.

As to specific examples of the compound, the description in Paragraph No. [0017] of JP-A-2007-256844 or the like can be referred to.

Use of isocyanuric acrylate is preferred because the curling can be reduced. The isocyanuric acrylate include an isocyanuric diacrylate and an isocyanuric triacrylate. As to specific examples of the compound, the description in Paragraph Nos. [0018] to [0021] of JP-A-2007-256844 or the like can be referred to

An epoxy compound can further be used in the hardcoat layer for reducing the shrinkage of the layer due to curing. As an epoxy group-containing monomer to constitute the compound, a monomer having 2 or more epoxy groups per molecule is used. Examples of the monomer include epoxy monomers described, for example, in JP-A-2004-264563, JP-A-2004-264564, JP-A-2005-37737, JP-A-2005-37738, JP-A-2005-140862, JP-A-2005-140862, JP-A-2005-140863 and JP-A-2002-322430. Also, a compound having both epoxy and acrylic functional groups, for example, glycidyl (meth)acrylate can be preferably used.

### (Polymer Compound)

The hardcoat layer may contain a polymer compound. The description and preferred specific examples of the polymer compound are same as those described in JP-A-2012-215812 and the contents thereof are incorporated herein by reference.

### (Curable Composition)

The description and preferred specific examples of the curable composition usable for the formation of the hardcoat layer are same as those described in JP-A-2012-215812 and the contents thereof are incorporated herein by reference.

### (Property of Hardcoat Layer)

It is preferred that the hardcoat layer is excellent in abrasion resistance. Specifically, when the hardcoat layer is subjected to a pencil hardness test which is an index of the abrasion resistance, the hardcoat layer attains 3H or more.

The polarizing plate according to the invention may have other layer in addition to the optical film according to the invention and the hardcoat layer described above, in order to exhibit functions suitable for respective uses. For example, it may have as well as an antiglare layer or a clear hardcoat layer, an antireflective layer, an antistatic layer or an antifouling layer.

Also, since fingerprint adhesion resistance or an antifouling property is required for an image display screen having a touch panel of various systems which has been particularly spread in recent years, it is also useful to form a fingerprint adhesion resistant layer or an antifouling layer on the optical film according to the invention.

As to the fingerprint adhesion resistant layer or antifouling layer, Japanese Patent Nos. 4517590 and 4638954, WO 2010/090116, WO 2011/105594 can be referred to.

The image display device is not also particularly limited. The display device may be a liquid crystal display device having a liquid crystal cell, an organic EL image display device having an organic EL layer or a plasma image display device. A cellulose acylate polymer layer, a polyester polymer layer, an acrylic polymer layer, a cycloolefin polymer layer and a layer made from a composition containing a liquid crystal compound have a good sticking property with a polarizer so that they are suitable for use in a liquid crystal display device in which a polarizing plate is the indispensable member.

In the production of polarizing plate, when the optical film according to the invention has an in-plane slow axis, it is preferably stuck with a polarizer in such a manner that the in-plane slow axis of the optical film is crossed parallel to or perpendicular to the transmission axis of the polarizer.

### [Liquid Crystal Image Display Device]

The liquid crystal image display device according to the invention has at least one sheet of the polarizing plate according to the invention.

According to one example of arrangement method of the optical film according to the invention in the polarizing plate, the optical film according to the invention in the state having no functional layer, for example, a hardcoat layer is a surface protective film of the polarizing plate which is arranged on the outside of a polarizer (that is, the optical film is arranged further from the liquid crystal cell than the polarizer of the polarizing plate). According to another example of arrangement method of the optical film according to the invention, the optical film according to the invention in the state having a functional layer, for example, a hardcoat layer in the polarizing plate of the display surface side is a surface protective film of the polarizing plate which is arranged on the outside of a polarizer (that is, the optical film is arranged further from the liquid crystal cell than the polarizer of the polarizing plate). In the liquid crystal display device according to the invention, it is also preferred that the polarizing plate is arranged in such a manner that the optical film according to the invention is arranged closer to the liquid crystal cell than the other protective film.

For the other configuration of the device, any configuration in known liquid crystal display devices can be employed. The display mode of the device is also not particularly limited. The optical film according to the invention can be constituted in the liquid crystal display devices of various display modes, for example, TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) or HAN (hybrid aligned nematic).

As the liquid crystal display device according to the invention, a transmission type liquid crystal display device is preferred. The transmission type liquid crystal display device is ordinarily constituted by a backlight, a liquid crystal cell and two polarizing plates having transmission axes crossed orthogonal to each other, and the two polarizing plates are stuck on the viewing side and the backlight side of the liquid crystal cell through an adhesive layer.

The liquid crystal cell has a liquid crystal layer and two glass substrates provided on the both sides of the liquid crystal layer. As the glass substrate for the liquid crystal display device, silicate glass is used, silica glass or borosilicate glass is preferably used, and alkali-free borosilicate glass is most preferably used. When the glass substrate for the liquid crystal display device contains an alkali component, the alkali component may dissolve out to damage TFT. The alkali-free borosilicate glass is glass substantially free of an alkali component, specifically glass which contains the alkali component of 1,000 ppm or less. The content of the alkali component according to the invention is preferably 500 ppm or less, and more preferably 300 ppm or less.

The glass substrate for the liquid crystal display device is a planar-view approximately rectangular-shaped plate-like body, and a thickness of the plate is preferably from 0.01 to 1.1 mm. When the thickness is 0.01 mm or more, the glass substrate is insusceptible to interference of light, internal strain due to deformation of glass substrate for evaluation object display or the like, whereas when it is 1.1 mm or less, the brightness at time of evaluation is hard to decrease. The thickness of the plate is more preferably from 0.1 to 0.7 mm, and still more preferably from 0.1 to 0.5 mm

A method for sticking the polarizing plate according to the invention to a liquid crystal display device is not particularly limited, and polarizing plates having a size of a display surface of liquid crystal display device may be prepared and stuck on both surfaces of liquid crystal cell, respectively.

As the method for sticking the polarizing plate according to the invention to a liquid crystal display device, a roll-to-panel production method can be used, and the method is preferred in view of increase in productivity and yield ratio. The roll-to-panel production method is described in JP-A-2011-48381, JP-A-2009-175653, Japanese Patent Nos. 4628488 and 4729647, WO 2012/014602 and WO 2012/014571, but the method should not be construed as being limited thereto.

The method for sticking the polarizing plate according to the invention to a liquid crystal display device may be a sticking method including a first cutting and sticking step wherein using a roll on which a band-like sheet product of a first polarizing plate having a width corresponding to a short side of the display surface of liquid crystal display device is wound, the first polarizing plate is cut in a length corresponding to a long side of the display surface of liquid crystal display device and stuck to one display surface of liquid crystal cell of liquid crystal display device, and a second cutting and sticking step wherein using a roll on which a band-like sheet product of a second polarizing plate having a width corresponding to a long side of the display surface of liquid crystal display device is wound, the second polarizing plate is cut in a length corresponding to a short side of the display surface of liquid crystal display device and stuck to another display surface of liquid crystal cell of liquid crystal display device.

According to the method described above, by using a roll of polarizing plate having a width corresponding to a short side of the display surface of liquid crystal display device and a roll of polarizing plate having a width corresponding to a long side of the display surface of liquid crystal display device, each of the polarizing plates corresponding to the short side and the long side of the optical display unit of the display surface of liquid crystal display device can be obtained only by cutting the polarizing plate supplied from the roll at a regular interval. Thus, by cutting the former to a length corresponding to the long side and cutting the latter to a length corresponding to the short side and sticking them to both surfaces of a liquid crystal cell of liquid crystal display device, upper and lower polarizing plates can be stuck to a liquid crystal cell in such a manner that optical anisotropy, for example, an absorption axis thereof are orthogonally crossed using two rolls of polarizing plate having the same optical anisotropy, for example, an absorption axis.

In the sticking according to the method described above, a sticking system is preferably used, which comprise a supply device of liquid crystal cell for supplying a liquid crystal cell, a supply device of the first polarizing plate for pulling out a band-like sheet product of the first polarizing plate from a roll on which the band-like sheet product of the first polarizing plate is wound and supplying the first polarizing plate after cutting to a predetermined length, a first sticking device for sticking the first polarizing plate supplied from the supply device of the first polarizing plate to one surface of the liquid crystal cell supplied from the supply device of liquid crystal cell, a transport supply device for transporting and supplying the liquid crystal cell after sticking of the first polarizing plate, a supply device of the second polarizing plate for pulling out a band-like sheet product of the second polarizing plate from a roll on which the band-like sheet product of the second polarizing plate is wound and supplying the second polarizing plate after cutting to a predetermined length, and a second sticking device for sticking the second polarizing plate supplied from the supply device of the second polarizing plate to the other surface of the liquid crystal cell supplied from the transport supply device and wherein the supply device of the first polarizing plate and the supply device of the second polarizing plate are constituted in such a manner that corresponding to the long side and short side of the liquid crystal cell, one of the supply devices cuts the polarizing plate having a width corresponding to the short side to a length corresponding to the long side and the other of the supply devices cuts the polarizing plate having a width corresponding to the long side to a length corresponding to the short side.

### EXAMPLES

### Production of Film 1

67% by weight of pellets of [a mixture of 90 parts by weight of an acrylic resin having a lactone ring structure represented by formula (1) shown below {copolymerization monomer weight ratio: methyl methacrylate/methyl 2-(hydroxymethyl)acrylate=8/2, lactone ring formation rate: about 100%, content ratio of lactone ring structure: 19.4% by weight, weight average molecular weight: 133,000, melt flow rate: 6.5 g/10 minutes (240° C., 10 kgf), Tg: 131° C.} and 10 parts by weight of an acrylonitrile-styrene (AS) resin {TOYO AS AS20 produced by Toyo Styrene Co., Ltd}; Tg: 127° C.] and 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) were supplied to a twin screw extruder and was melt-extruded at about 280° C. into a sheet form to obtain Film 1 of a long film having a thickness of 40 μm.

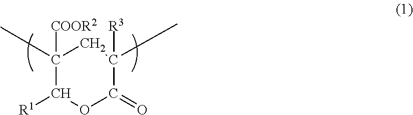

In formula (1), R¹ represents a hydrogen atom, and R² and R³ each represents a methyl group.

### Production of Film 2

Film 2 was produced under the same conditions as in Film 1 except for changing the amount of the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 44% by weight.

### Production of Film 3

Film 3 was produced under the same conditions as in Film 1 except for changing 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 33% by weight of an acrylic block copolymer (LA POLYMER 4285, produced by Kuraray Co., Ltd.).

### Production of Film 4

67% by weight of an imidized resin prepared by the method described in “Production Example 1” of JP-A-2010-270162 and 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) were supplied to a twin screw extruder and was melt-extruded at 270° C. into a sheet form to obtain Film 4 of a long film having a thickness of 40 μm.

### Production of Film 5

Film 5 was produced under the same conditions as in Film 4 except for changing the amount of the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 44% by weight.

### Production of Film 6

Film 6 was produced under the same conditions as in Film 4 except for changing 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 33% by weight of an acrylic block copolymer (LA POLYMER 4285, produced by Kuraray Co., Ltd.).

### Production of Film 7

Film 7 was produced under the same conditions as in Film 1 except for not adding the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.).

### Production of Film 8

Film 8 was produced under the same conditions as in Film 1 except for changing the amount of the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 20% by weight.

### Production of Film 9

Film 9 was produced under the same conditions as in Film 1 except for changing 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 20% by weight of a condensate of adipic acid and butanediol (sealed with acetic acid, Mw: 1,000) (Ester Compound (1) shown below).

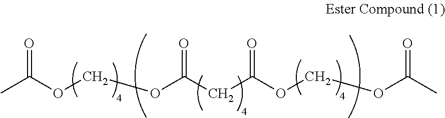

### Production of Film 10

Film 10 was produced under the same conditions as in Film 4 except for not adding the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.).

### Production of Film 11

Film 11 was produced under the same conditions as in Film 4 except for changing the amount of the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 20% by weight.

### Production of Film 12

Film 12 was produced under the same conditions as in Film 4 except for changing 33% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 20% by weight of a condensate of adipic acid and butanediol (sealed with acetic acid, Mw: 1,000) (Ester Compound (1) shown above).

### Production of Film 13

A commercially available norbornene polymer film (ZEONOR ZF14-060, produced by Optes Co., Ltd.) was prepared to use as Film 13.

### Production of Film 14

Pellets of [a mixture of 90 parts by weight of an acrylic resin having a lactone ring structure represented by formula (1) shown below {copolymerization monomer weight ratio: methyl methacrylate/methyl 2-(hydroxymethyl)acrylate/butyl acrylate=4.8/1.2/4, lactone ring formation rate: about 100%} and 10 parts by weight of an acrylonitrile-styrene (AS) resin {TOYO AS AS20 produced by Toyo Styrene Co., Ltd}; Tg: 127° C.] was supplied to a twin screw extruder and melt-extruded at about 280° C. into a sheet form to obtain Film 14 of a long film having a thickness of 40 μm.

### Production of Film 15

An imidized resin (copolymerization monomer ratio: methyl methacrylate/glutarimide/butyl acrylate =55/5/40) was supplied to a twin screw extruder and melt-extruded at about 280° C. into a sheet form to obtain Film 15 of a long film having a thickness of 40 μm.

The imidized resin is a resin prepared in the same manner as in the method described in “Production Example 1” of JP-A-2010-270162 except for changing the raw material resin from methyl methacrylate polymer (Mw: 105,000) to copolymer of methyl methacrylate/butyl acrylate=60/40.

### Production of Film 16

71% by weight of a resin having a ratio of methyl methacrylate:methyl acrylate of 96:4% by weight and a weight average molecular weight of 100,000 and 29% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) were supplied to a twin screw extruder and extruded to produce Film 16 having a thickness of 40 μm.

### Formation of Film 17

Film 17 was produced under the same conditions as in Film 16 except for changing the amount of the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 38% by weight.

### Production of Film 18

Film 18 was produced under the same conditions as in Film 16 except for changing 29% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 33% by weight of an acrylic block copolymer (LA POLYMER 4285, produced by Kuraray Co., Ltd.).

### Production of Film 19

Film 19 was produced under the same conditions as in Film 16 except for changing 29% by weight of rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.) to 20% by weight of a condensate of adipic acid and butanediol (sealed with acetic acid, Mw: 1,000) (Ester Compound (1) shown above).

### Production of Film 20

A resin having a copolymerization weight ratio of methyl methacrylate:methyl acrylate:butyl acrylate of 56:4:40 and a weight average molecular weight of 100,000 was supplied to a twin screw extruder and extruded to produce Film 20 having a thickness of 40 μm.

### Production of Film 21

Film 21 was produced under the same conditions as in Film 16 except for not adding the rubber particles having multilayer structure (core: an acrylic rubber of multilayer structure, shell: an acrylic polymer containing methyl methacrylate as a main component, approximate particle size: 220 nm) (KANE ACE M210, produced by Kaneka Corp.).

### Production of Film 22

Film 22 was produced by the method described in “Example 1” of JP-A-2010-65109.

### Production of Film 23

Film 23 was produced by the method described in “Example 1” of JP-T-2010-540693.

### Production of Film 24

A commercially available cellulose acetate film (FUJITAC TD60, produced by Fujifilm Corp.) was prepared to use as Film 24.

### Production of Film 25

### (Synthesis of Raw Material Polyester)

### (Raw Material Polyester 1)

A polyester (Sb catalyst PET) was obtained by a continuous polymerization apparatus using a direct esterification method wherein terephthalic acid and ethylene glycol are directly reacted and water is distilled off to perform esterification and then polycondensation is performed under a reduced pressure as shown below.

### (1) Esterification Reaction

By mixing 4.7 tons of high purity terephthalic acid and 1.8 tons of ethylene glycol over 90 minutes to form a slurry, and the slurry was continuously supplied to a first esterification reaction tank at a flow rate of 3,800 kg/h. Further, an ethylene glycol solution of antimony trioxide was continuously supplied to the first esterification reaction tank, and a reaction was carried out with stirring at a temperature inside the reaction tank of 250° C. for an average retention time of about 4.3 hours. At this time, the antimony trioxide was continuously added such that the addition amount of Sb calculated in terms of element was 150 ppm.

The reaction product was transferred to a second esterification reaction tank and reacted with stirring at a temperature inside the reaction tank of 250° C. for an average retention time of 1.2 hours. To the second esterification reaction tank were continuously supplied an ethylene glycol solution of magnesium acetate and an ethylene glycol solution of trimethyl phosphate such that the addition amounts of Mg and P calculated in terms of element were 65 ppm and 35 ppm, respectively.

### (2) Polycondensation Reaction

The esterification reaction product obtained as described above was continuously supplied to a first polycondensation reaction tank and subjected to polycondensation with stirring at a reaction temperature of 270° C. and a pressure inside the reaction tank of 20 torr (2.67×10⁻³ MPa) for an average retention time of about 1.8 hours.

Further, the reaction product was transferred to a second polycondensation reaction tank and subjected to a reaction (polycondensation) with stirring in the reaction tank under the conditions of a temperature inside the reaction tank of 276° C. and a pressure inside the reaction tank of 5 torr (6.67×10⁴ MPa) for a retention time of about 1.2 hours.

Subsequently, the reaction product was further transferred to a third polycondensation reaction tank and subjected to a reaction (polycondensation) in the reaction tank under the conditions of a temperature inside the reaction tank of 278° C. and a pressure inside the reaction tank of 1.5 torr (2.2×10⁴ MPa) for a retention time of 1.5 hours, thereby obtaining a reaction product (polyethylene terephthalate (PET)).

Then, the reaction product obtained was ejected in cold water into a strand form, and the strands were immediately cut to produce pellets of polyester (cross-section: major axis about 4 mm, minor axis about 2 mm, length: about 3 mm>

The polymer (hereinafter abbreviated as PET1) obtained had IV of 0.63.

### (Raw Material Polyester 2)

Ten parts by weight of dried ultraviolet absorbing agent (2,2′-(1,4-phenylene)bis(4H-3,1-benzoxazin-4-one) and 90 parts by weight of PET1 (IV of 0.63) were mixed using a kneading extruder to obtain Raw material polyester 2 containing the ultraviolet absorbing agent (hereinafter abbreviated as PET2).

### (Film Molding Step)

After drying 90 parts by weight of Raw material polyester 1 (PET1) and 10 parts by weight of Raw material polyester 2 (PET2) containing the ultraviolet absorbing agent to a moisture content of 20 ppm or less, they were charged into a hopper of a single screw kneading extruder with a diameter of 50 mm and melted at 300° C. in the extruder. The resulting melted resin was passed through a gear pump and a filter (having a pore diameter of 20 μm) and extruded from a die under the extrusion conditions shown below.

The melted resin was extruded from the die under the extrusion conditions of a pressure fluctuation of 1% and a temperature distribution of the melted resin of 2%. Specifically, the back pressure was pressurized 1% relative to the average pressure in the barrel of the extruder and a piping of the extruder was heated at a 2% higher temperature relative to the average temperature in the barrel of the extruder.

The melted resin was extruded from the die onto a cooling cast drum set at a temperature of 25° C. and adhered to the cooling cast drum by using an electrostatic charging method. The film was peeled by using a peeling roll disposed opposing to the cooling cast drum to obtain an unstretched polyester film

### (Transverse Stretching Step)

The unstretched polyester film was introduced into a tenter (transverse stretching machine) and stretched according to the method and conditions shown below while being grasped with clips at the ends thereof.

### (Preheating Unit)

The preheating temperature was set 95° C. and heated to a stretchable temperature.

### (Stretching Unit)

The unstretched polyester film preheated was transversely stretched in a width direction under the conditions shown below.

### <Conditions>

Transverse stretching temperature: 95° C.
Transverse stretching ratio: 4.7 times

### (Heat Fixation Unit)

Then, the heat fixation treatment was carried out while controlling a film surface temperature of the polyester film to the range shown below.

### <Conditions>

Heat fixation temperature: 180° C.
Heat fixation time: 15 seconds

### (Heat Relaxation Unit)

The polyester film after the heat fixation was heated at the temperature shown below to relax the film.

Heat relaxation temperature: 170° C.
Heat relaxation rate: 2% in TD direction (film width direction)

### (Cooling Unit)

Then, the polyester film after the heat relaxation was cooled at a cooling temperature of 50° C.

### (Collection of Film)

After the cooling, both ends of the film were subjected to 20 cm trimming respectively. After that, a press processing (knurling) of 10 mm width was applied on both ends of the film, and then the film was wound up at a tension of 18 kg/m.

Thus, Film 25 of polyester polymer having a thickness of 60 μm was obtained.

### Production of Film 26

A commercially available cellulose acylate film (ZRD40, produced by Fujifilm Corp.) was prepared to use as Film 26. A thickness of Film 26 was 41 μm.

### Production of Film 27

### (Preparation of Cellulose Acylate)

A cellulose acylate was synthesized by the methods described in JP-A-10-45804 and JP-A-8-232761 and a substitution degree of the cellulose acylate was measured. Specifically, sulfuric acid (7.8 parts by weight based on 100 parts by weight of cellulose) was added as a catalyst, a carboxylic acid was added as a raw material for an acyl substituent, and an acylation reaction was performed at 40° C. The kind and substitution degree of the acyl group were adjusted by controlling the kind and amount of the carboxylic acid. After the acylation, the product was ripened at 40° C. Further, a low molecular weight component of the cellulose acylate was removed by washing with acetone.

### (Preparation of Cellulose Acylate Solution for Low Substitution Degree Layer)

The composition shown below was charged into a mixing tank and stiffed to dissolve the components, thereby preparing a cellulose acylate solution.

| | | |
|---|---|---|
| Cellulose acetate | 100.0 | parts by weight |
| (substitution degree: 2.45) | | |
| Optical generator B shown below | 1.3 | parts by weight |
| Additive shown below (polycondensation ester | 18.5 | parts by weight |
| of dicarboxylic acid and diol) | | |
| Methylene chloride | 365.5 | parts by weight |
| Methanol | 54.6 | parts by weight |

### (Preparation of Cellulose Acylate Solution for High Substitution Degree Layer)

The composition shown below was charged into a mixing tank and stiffed to dissolve the components, thereby preparing a cellulose acylate solution.

| | | |
|---|---|---|
| Cellulose acetate | 100.0 | parts by weight |
| (substitution degree: 2.79) | | |
| Additive shown below | 11.3 | parts by weight |
| (polycondensation ester of | | |
| dicarboxylic acids and diols) | | |
| Silica fine particle R 972 | 0.15 | parts by weight |
| (produced by Nippon Aerosil Co., Ltd.) | | |
| Methylene chloride | 395.0 | parts by weight |
| Methanol | 59.0 | parts by weight |

Optical generator B

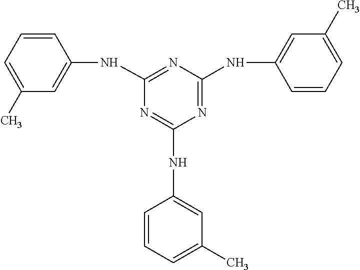 [SMILES: Cc1cccc(Nc2nc(Nc3cccc(C)c3)nc(Nc3cccc(C)c3)n2)c1]

Polycondensation ester: polycondensation ester of terephthalic acid and succinic acid as dicarboxylic acids and ethylene glycol and 1,2-propylene glycol as diols (terephthalic acid:succinic acid:ethylene glycol:1,2-propylene glycol=55:45:50:50 in molar ratio) (terminal: acetyl group, molecular weight: 800)

### (Preparation of Cellulose Acylate Film)

The cellulose acylate solution for low substitution degree layer and the cellulose acylate solution for high substitution degree layer were cast on a band so that the cellulose acylate solution for low substitution degree layer forms a core layer having a thickness of 36 μm and the cellulose acylate solution for high substitution degree layer forms a skin layer having a thickness of 2 μm on both surfaces of the core layer, respectively. The web (film) obtained was peeled from the band, grasped with clips and transversely stretched 14% at 130° C. in the state where the remaining solvent amount was from 20 to 5% based on the total weight of the film. Thereafter, the clips were removed from the film, and the film was dried at 130° C. for 20 minutes and again transversely stretched 27% at 180° C. using a tenter.

The remaining solvent amount was determined according to the formula shown below.

Remaining solvent amount (% by weight)={(M−N)/N)}×100

In the formula above, M represents a weight of a web at an optional time, and N represents a weight of the web measured M after drying at 120° C. for 2 hours.

Thus, Film 27 of thermoplastic resin was obtained (thickness: 40 μm, Re=50 nm, Rth=120 nm).

### Production of Film 28

### <Preparation of Cellulose Acylate Solution>

The cellulose acylate and composition shown below were charged into a mixing tank and stiffed to dissolve the components, thereby preparing Cellulose acylate solution 28.

### Composition of Cellulose Acylate Solution 28

| | | |
|---|---|---|
| Cellulose acetate having acetyl substitution | 100.0 | parts by weight |
| degree of 1.6 and propionyl substitution | | |
| degree of 0.9 | | |
| Sucrose benzoate having benzoate substitution | 8.0 | parts by weight |
| degree of 6.0 | | |
| Additive shown below (polycondensation ester | 2.0 | parts by weight |
| of dicarboxylic acids and diols) | | |
| Methylene chloride (first solvent) | 400.0 | parts by weight |
| Ethanol (second solvent) | 40.0 | parts by weight |

Polycondensation ester: polycondensation ester of terephthalic acid and adipic acid as dicarboxylic acids and ethylene glycol and 1,2-propylene glycol as diols (terephthalic acid:adipic acid:ethylene glycol:1,2-propylene glycol=55:45:50:50 in molar ratio) (terminal: acetyl group, molecular weight: 1,200)

### <Preparation of Matting Agent Solution>

The composition shown below was charged into a disperser and stirred to dissolve the components, thereby preparing a matting agent solution.

### Composition of Matting Agent Solution

| | | |
|---|---|---|
| Silica particle having average particle size | 1.6 | parts by weight |
| of 16 nm (AEROSIL R972, produced by Nippon | | |
| Aerosil Co., Ltd.) | | |
| Methylene chloride (first solvent) | 78.9 | parts by weight |
| Ethanol (second solvent) | 8.8 | parts by weight |
| Cellulose acylate solution 28 | 0.3 | parts by weight |

After filtering 1.0 parts by weight of the matting agent solution, was added to 92.7 parts by weight of Cellulose acylate solution 28, the mixture was mixed using an in-line mixer. The mixture was cast using a band casting apparatus and immediately dried at drying air temperature of 30° C. and drying air velocity of 1.4 m/s until the remaining solvent amount reached 40%, and the film was peeled from the band. The drying air used was fresh air having an organic solvent concentration of 1% or less. The film having the remaining solvent amount of 15% was transversely stretched at a stretching ratio of 1.36 times and stretching velocity of 150%/min using a tenter under ambient temperature of 130° C. and then maintained at 130° C. for 30 seconds. Thereafter, the clips were removed from the film, and the film was dried at 120° C. for 40 minutes to obtain Film 28 of thermoplastic resin (thickness: 40 μm, Re=50 nm, Rth=120 nm).

### Production of Film 29

A film (ZXEONOR 1420R, produced by Zeon Corp.) was longitudinally stretched by a vertical uniaxial stretching machine at a stretching ratio of 33%, a supply air temperature of 140° C. and a film surface temperature of 130° C. Then, the film was transversely stretched by a tenter stretching machine at a stretching ratio of 45%, a supply air temperature of 140° C. and a film surface temperature of 130° C., the both end portions thereof were cut out before a winding unit and wound as a roll film having a length of 4,000 m to obtain Film 29 of biaxially stretched thermoplastic resin (thickness: 40 μm, Re=50 nm, Rth=120 nm).

The film thickness (μm), elastic modulus (×10⁹ N/m²), glass transition temperature TG (° C.) and optical properties (nm) as used herein were measured in the manner shown below.

### [Measurement of Film Thickness]

A sample of 5 cm square was prepared, allowed to stand in an environment at 25° C. and relative humidity of 60% for 48 hours. Then, the thickness was measured at 6 points of the sample and an average value thereof was used as the film thickness.

### [Measurement of Modulus of Elongation]

As to the modulus of elongation (GPa), a sample having a length in the measuring direction of 200 mm and a width of 10 mm was prepared, allowed to stand in an environment at 25° C. and relative humidity of 60% for 48 hours. Then, using Strograph V10-C produced by Toyo Seiki Seisaku-sho, Ltd., a chuck distance in the longitudinal direction thereof was set 100 mm and a load was applied so as to widen the chuck interval at a stretching rate of 10 mm/min to measure the force at that time. The modulus of elongation was calculated from the thickness of the film preliminarily measured by a micrometer, the force and the elongation amount.

### [Measurement of Reduction Amount of Modulus of Elongation]

Using (E(A)−E(0))/A in formula (1) or (E2(A2)−E2(0))/A2 in formula (2), the reduction amount of modulus of elongation was determined

As the value for A, a content ratio (% by weight) of the elastic modulus reducing agent in the optical film shown in Table 1 below was adopted.

As the value for A2, a content ratio (% by weight) of a repeating unit derived from the elastic modulus reducing monomer shown in Table 1 below was adopted.

### [Measurement of Glass Transition Temperature Tg]

The measurement of the glass transition temperature was performed using a dynamic viscoelasticity measuring device as described below. A 5 mm×30 mm film sample (unstretched) was subjected to humidity conditioning at 25° C. and 60% RH for 2 hours or more and then measured by a dynamic viscoelasticity measuring device (VIBRON DVA-225, produced by IT Keisoku Seigyo K.K.) under the conditions of a grip-to-grip distance of 20 mm, a temperature rising rate of 2° C./minute, a measuring temperature range from 30 to 250° C. and a frequency of 1 Hz. When the storage elastic modules was taken as a logarithmic axis on the vertical axis and the temperature (° C.) was taken as a linear axis on the horizontal axis and when a drastic decrease in the storage elastic modules which was observed in the process where the storage elastic modules moved from a solid region to a glass transition region was drawn as line 1 in the solid region and drawn as line 2 in the glass transition region, an intersection point of lines 1 and 2 corresponded to the temperature at which the storage elastic modules drastically decreased upon increasing temperature and the film initiated to soften and at which the film initiated to move to the glass transition region. Thus, the temperature was taken as the glass transition temperature Tg (dynamic viscoelasticity).

### [Measurement of Tg(C)−Tg(D)]

Taking a glass transition temperature of the optical film of each of the examples and comparative examples as Tg(C), and taking a glass transition temperature of a film not containing the elastic modulus reducing agent or the repeating unit derived from the elastic modulus reducing monomer of the optical film of each of the examples and comparative examples as Tg(D), a value of Tg(C)−Tg(D) was obtained.

### [Measurement of Optical Properties]

Each film was subjected to humidity conditioning at 25° C. and 60% relative humidity for 24 hours and retardation at a wavelength of 590 nm was measured from the direction perpendicular to the film surface and the directions tilted from the film plane normal by 10° in the range from +50° to −50° using a slow axis as the rotation axis at 25° C. and 60% relative humidity by an automatic birefringence meter (KOBRA-21ADH, produced by Oji Scientific Instruments Co., Ltd.), and the in-plane retardation value (Re) and the thickness direction retardation value (Rth) were calculated. The direction of the in-plane slow axis corresponds to a direction in which the refractive index in the plane in maximum and the “MD” in Table 1 indicates that the in-plane slow axis is present in the direction in the range of ±5° with respect to the MD direction of film. The “TD” in Table 1 indicates that the in-plane slow axis is present in the direction in the range of ±5° with respect to the TD direction of film.

Also, ΔRe was determined by the formula shown below.

ΔRe=Re(10)−Re(0)≦10

In the formula, nx represents a refractive index in a film in-plane slow axis direction, ny represents a refractive index of in a film in-plane fast axis direction, d represents a thickness (nm) of the film, Re(10) represents a retardation value when the film is stretched 10%, and Re(0) represents a retardation value in an unstretched state.

Films 1 to 23 produced according to the methods described above was uniaxially stretched 10% in the TD direction at a rate of 30%/min at the glass transition temperature, thereby producing Stretched films 1 to 23, respectively.

### [Evaluation of Optical Unevenness]

The optical unevenness when the stretched film produced was observed under the cross-Nicol condition was evaluated.

A: The optical unevenness cannot be visually observed.
B: The optical unevenness can be visually observed.

As to Stretched films 13 and 23 produced according to the methods described above, large optical unevenness in the plane was observed.

TABLE 1

| | | | | Elastic | | | | | |
|---|---|---|---|---|---|---|---|---|---|
| | | | | Modulus Reducing | | | | | |
| | Elastic Modulus | | | Monomer | | | | | Reduction |
| | Reducing Agent | | | | Copoly- | | | Ratio of | Amount of |
| | | | Addition | | meri- | Modulus of | | Modulus | Modulus of |
| | Incom- | Com- | Amount | | zation | Elongation | | of | Elongation |
| | patible | patible | (% by | | Ratio (% | (× 10⁹ N/m²) | | Elongation | ΔE(A), |
| | Resin | Compound | weight) | Kind | by weight) | MD | TD | MD/TD | ΔE2(A2) |
| Film 1 | Kane Ace | — | 33 | — | — | 2.2 | 2.0 | 1.08 | −0.022 |
| | M210 | | | | | | | | |
| Film 2 | Kane Ace | — | 44 | — | — | 1.6 | 1.5 | 1.08 | −0.022 |
| | M210 | | | | | | | | |
| Film 3 | LA4285 | — | 33 | — | — | 2.1 | 1.9 | 1.08 | −0.025 |
| Film 9 | — | Ester | 20 | — | — | 2.0 | 1.9 | 1.08 | −0.051 |
| | | Compound | | | | | | | |
| | | (1) | | | | | | | |
| Film 14 | — | — | — | Butyl | 40 | 1.6 | 1.5 | 1.08 | −0.021 |
| | | | | Acrylate | | | | | |
| Film 4 | Kane Ace | — | 33 | — | — | 2.2 | 2.0 | 1.08 | −0.022 |
| | M210 | | | | | | | | |
| Film 5 | Kane Ace | — | 44 | — | — | 1.6 | 1.5 | 1.08 | −0.022 |
| | M210 | | | | | | | | |
| Film 6 | LA4285 | — | 33 | — | — | 2.1 | 1.9 | 1.08 | −0.025 |
| Film 12 | — | Ester | 20 | — | — | 2.0 | 1.9 | 1.08 | −0.051 |
| | | Compound | | | | | | | |
| | | (1) | | | | | | | |
| Film 15 | — | — | — | Butyl | 40 | 1.6 | 1.5 | 1.08 | −0.021 |
| | | | | Acrylate | | | | | |
| Film 16 | Kane Ace | — | 29 | Methyl | 4 | 2.1 | 1.9 | 1.08 | −0.022 |
| | M210 | | | Acrylate | | | | | |
| Film 17 | Kane Ace | — | 38 | Methyl | 4 | 1.6 | 1.5 | 1.08 | −0.022 |
| | M210 | | | Acrylate | | | | | |
| Film 18 | LA 4285 | — | 33 | Methyl | 4 | 1.8 | 1.6 | 1.08 | −0.025 |
| | | | | Acrylate | | | | | |
| Film 19 | — | Ester | 20 | Methyl | 4 | 1.7 | 1.6 | 1.08 | −0.051 |
| | | Compound | | Acrylate | | | | | |
| | | (1) | | | | | | | |
| Film 20 | — | — | — | Methyl | 4 | 1.7 | 1.6 | 1.08 | −0.021 |
| | | | | Acrylate | | | | | |
| | | | | Butyl | 40 | | | | |
| | | | | Acrylate | | | | | |
| Film 7 | — | — | — | — | — | 3.3 | 3.1 | 1.08 | — |
| Film 8 | Kane Ace | — | 20 | — | — | 2.7 | 2.5 | 1.08 | −0.022 |
| | M210 | | | | | | | | |
| Film 10 | — | — | — | — | — | 3.3 | 3.1 | 1.08 | — |
| Film 11 | Kane ace | — | 20 | — | — | 2.7 | 2.5 | 1.08 | −0.022 |
| | M210 | | | | | | | | |
| Film 21 | — | — | — | — | — | 3.0 | 2.8 | 1.08 | — |
| Film 13 | — | — | — | — | — | 2.0 | 1.9 | 1.08 | — |
| Film 22 | Rubber | — | 10 | — | — | 3.0 | 2.8 | 1.08 | −0.030 |
| | Polymer | | | | | | | | |
| Film 23 | Core-shell | — | 25 | — | — | 2.6 | 2.4 | 1.08 | −0.021 |
| | Type Graft | | | | | | | | |
| | Polymer | | | | | | | | |
| Film 24 | — | — | — | — | — | — | — | — | — |
| Film 25 | — | — | — | — | — | — | — | — | — |
| Film 26 | — | — | — | — | — | — | — | — | — |
| Film 27 | — | — | — | — | — | — | — | — | — |
| Film 28 | — | — | — | — | — | — | — | — | — |
| Film 29 | — | — | — | — | — | — | — | — | — |

| | Glass | | | | | | | |
|---|---|---|---|---|---|---|---|---|
| | Transition | | | After Stretching | | | | |
| | Temperature | Before Stretching | | | | | Optical | |
| | (° C.) | Optical Properties (nm) | | | | | Unevenness of | |
| | Tg(C) − Tg(D) | Re | Rth | Re | Rth | ΔRe | Film | Remarks |
| Film 1 | 5 | 2 | −3 | — | — | 0 | A | Example |
| Film 2 | 8 | 2 | −5 | — | — | 0 | A | Example |
| Film 3 | 6 | 2 | 4 | — | — | 0 | A | Example |
| Film 9 | −40 | 2 | 0 | — | — | 0 | A | Example |
| Film 14 | −20 | 2 | 0 | — | — | 0 | A | Example |
| Film 4 | 5 | 1 | −1 | — | — | 0 | A | Example |
| Film 5 | 8 | 1 | −1 | — | — | 0 | A | Example |
| Film 6 | 6 | 0 | 6 | — | — | 0 | A | Example |
| Film 12 | −40 | 1 | 2 | — | — | 0 | A | Example |
| Film 15 | −20 | 1 | 2 | — | — | 0 | A | Example |
| Film 16 | 5 | 0 | −6 | — | — | 2 | A | Example |
| Film 17 | 8 | 0 | −8 | — | — | 2 | A | Example |
| Film 18 | 6 | 0 | 3 | — | — | 2 | A | Example |
| Film 19 | −40 | 0 | −1 | — | — | 2 | A | Example |
| Film 20 | −20 | 0 | −1 | — | — | 2 | A | Example |
| Film 7 | — | 2 | −3 | — | — | 0 | A | Comparative Example |
| Film 8 | 2 | 2 | −2 | — | — | 0 | A | Comparative Example |
| Film 10 | — | 1 | −1 | — | — | 0 | A | Comparative Example |
| Film 11 | 2 | 1 | −1 | — | — | 0 | A | Comparative Example |
| Film 21 | — | 1 | −4 | — | — | 2 | A | Comparative Example |
| Film 13 | — | 4 | 4 | — | — | 20 | B | Comparative Example |
| Film 22 | −1 | 2 | −3 | — | — | 0 | A | Comparative Example |
| Film 23 | −1 | 1 | −6 | — | — | 12 | B | Comparative Example |
| Film 24 | — | 2 | 42 | — | — | — | — | Comparative Example |
| Film 25 | — | — | — | 6500 | 6500 | — | — | Comparative Example |
| Film 26 | — | 2 | −5 | — | — | — | — | Comparative Example |
| Film 27 | — | — | — | 50 | 120 | — | — | Comparative Example |
| Film 28 | — | — | — | 50 | 120 | — | — | Comparative Example |
| Film 29 | — | — | — | 50 | 120 | — | — | Comparative Example |

<Production of Films 1 to 25 with Hardcoat Layer>

### [Preparation of Coating Composition HCL-1 for Forming Hardcoat Layer]

Eight parts by weight of pentaerythritol triacrylate, 0.5 parts by weight of IRGACURE 127 (produced by BASF) and 4 parts by weight of difunctional acrylic compound represented by formula C-3 shown below were mixed to prepare Coating composition HCL-1 for forming hardcoat layer.

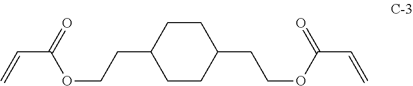 [SMILES: C=CC(=O)OCCC1CCC(CCOC(=O)C=C)CC1]

### [Production of Hardcoat Layer]

Coating composition HCL-1 for forming hardcoat layer was coated on each of Optical films 1 to 25 produced above by a die coating method and dried at 80° C. for 5 minutes, and the coated layer was cured by irradiating an ultraviolet ray at an irradiation dose of 300 mJ/cm² using an air-cooled metal halide lamp (produced by Eye Graphics Co., Ltd.) of 240 W/cm under nitrogen purge to form a hardcoat layer having a dry thickness of 5 μm.

Thus, Films 1 to 25 with hardcoat layer having the hardcoat layer on Films 1 to 25 were produced, respectively.

### <Production of Polarizing Plate>

### [Production of Polarizer]

A polarizer having a thickness of 20 μm was produced by adsorbing iodine to a stretched polyvinyl alcohol film. As to the production method of polarizer, for example, the method described in Example 1 of JP-A-2001-141926 may be used, or a polarizer may be produced by stretching a PVA layer formed on an amorphous PET base material as Polarizing film (1) described in JP-A-2013-8019.

### [Production of Polarizing Plate Used in Liquid Crystal Display Device 3]

### (Production of Polarizing Plate Using Sticking Method A)

### [Adhesive for Polarizing Plate]

One hundred parts by weight of 2-hydroxyethyl acrylate, 10 parts by weight of tolylene diisocyanate and 3 parts by weight of a photopolymerization initiator (IRGACURE 907, produced by BASF) were blended to prepare an adhesive for polarizing plate.

Film 1 with hardcoat layer and Film 1 both of which were the long optical films produced according the methods described above were prepared. The adhesive for polarizing plate was coated on the two films so as to have a thickness of 5 μm using a microgravure coater (gravure roll: #300, rotation speed 140%/line speed) to produce two optical films with adhesive. Then, the two optical films with adhesive were stuck on both surfaces of the polarizer having a thickness of 20 μm by a roll machine in a roll-to-roll manner so that the polarizer was sandwiched between the two optical films. From the optical film sides (both sides) stuck, an ultraviolet ray was irradiated to produce a front side polarizing plate of Liquid crystal display device 3 shown in Table 2 below. The line speed was 20 m/min and the accumulated light amount of the ultraviolet ray was 300 mJ/cm². In the above case the polarizer and the films were disposed in such a manner that the transmission axis of the polarizer was orthogonally crossed with the transporting direction of the films. A rear side polarizing plate of Liquid crystal display device 3 shown in Table 2 below was produced in the same manner as in the production of the front side polarizing plate except for using Film 1 in place of Film 1 with hardcoat layer.

### [Production of Polarizing Plates Used in Liquid Crystal Display Devices 1 to 2, 5 to 26 and 28 to 39]

A front side polarizing plate and a rear side polarizing plate of each liquid crystal display device were produced in the same manner as the polarizing plates used in Liquid crystal display device 3 except for changing the films used in the sticking in the production of the polarizing plates used in Liquid crystal display device 3 to a combination of films shown in Table 2 below. In the above cases the polarizer and the films were disposed in such a manner that the transmission axis of the polarizer was orthogonally crossed with the transporting direction of the films

### [Production of Polarizing Plate Used in Liquid Crystal Display Device 4]

### (Production of Polarizing Plate Using Sticking Method B)

Surfaces of Film 1 with hardcoat layer and Film 1 both of which were the long optical films produced according the methods described above were subjected to corona treatment. Then, the two optical films subjected to corona treatment were stuck on both surfaces of the polarizer having a thickness of 20 μm by a roll machine in a roll-to-roll manner using a polyvinyl alcohol adhesive so that the polarizer was sandwiched between the two optical films and dried at 70° C. for 10 minutes or more to produce a front side polarizing plate of Liquid crystal display device 4 shown in Table 2 below. In the above case the polarizer and the films were disposed in such a manner that the transmission axis of the polarizer was orthogonally crossed with the transporting direction of the films. A rear side polarizing plate of Liquid crystal display device 4 shown in Table 2 below was produced in the same manner as in the production of the front side polarizing plate except for using Film 1 in place of Film 1 with hardcoat layer.

### [Production of Polarizing Plate Used in Liquid Crystal Display Device 27]

### [Saponification of Film]

Film 24 with hardcoat layer and Film 24 both of which were the long optical films produced according the methods described above were prepared. The films were immersed in an aqueous solution (saponification solution) containing 1.5 mol/L NaOH maintained at 55° C. for 2 minutes, washed with water, then immersed in an aqueous solution containing 0.05 mol/L sulfuric acid of 25° C. for 30 seconds, and passed through a water washing bath using running water for 30 seconds to make the films in the neutral condition. Then, after repeating three times draining by air knife to remove water, the films were retained in a drying zone at 70° C. for 15 seconds to be dried, thereby producing films with saponification treatment.

Surface of Film 1 which was the long optical film produced according the method described above was subjected to corona treatment. Then, Film 24 with hardcoat layer subjected to saponification treatment and Film 1 subjected to corona treatment were stuck on both surfaces of the polarizer having a thickness of 20 μm by a roll machine in a roll-to-roll manner using a polyvinyl alcohol adhesive so that the polarizer was sandwiched between the two optical films and dried at 70° C. for 10 minutes or more to produce a front side polarizing plate of Liquid crystal display device 27 shown in Table 2 below. In the above case the polarizer and the films were disposed in such a manner that the transmitting axis of the polarizer was orthogonally crossed with the transporting direction of the films. A rear side polarizing plate of Liquid crystal display device 27 shown in Table 2 below was produced in the same manner as in the production of the front side polarizing plate except for using Film 24 subjected to saponification treatment in place of Film 24 with hardcoat layer subjected to saponification treatment

### [Durability of Polarizing Plate]

### (Evaluation of Durability of Polarizing Plate)

With respect to the polarizing plates produced for each of the examples and comparative examples, orthogonal transmittances of the polarizer at a wavelength of 410 nm and a wavelength of 680 nm were measured according the method shown below.

Then, after preservation for 500 hours at 105° C. without humidity control (dry), the orthogonal transmittances of each polarizer were measured in the same manner as described above. The change in the orthogonal transmittances before and after the preservation was determined to evaluate the durability of polarizing plate. It is found that the polarizer is deteriorated in the polarizing plate using Film 13.

The relative humidity under the environment without humidity control was in a range from 0 to 20%.

### (Change in Orthogonal Transmittance)

The orthogonal transmittance CT of the polarizing plate was measured using an automatic polarizing film measuring device (VAP-7070, produced by JASCO Corp.). The measurement was performed at a wavelength of 410 nm and an average value of 10 times measurements was used.

Test of the durability of polarizing plate can be performed according to two modes including (1) mode of the polarizing plate alone and (2) mode of sticking of the polarizing plate to a glass through an adhesive, in the manner as described below. In the measurement using only the polarizing plate in mode (1), two samples in which a transparent protective film is sandwiched between two polarizers in such a manner that the absorption axes orthogonally cross each other are prepared. In the measurement using the sticking of the polarizing plate to a glass through an adhesive in mode (2), two samples (5 cm×5 cm) in which the polarizing plate is stuck on a glass through an adhesive so that a transparent protective film is faced to the glass side are prepared. The single plate orthogonal transmittance measurement is carried out by setting the film side of the sample so as to face a light source. The two samples are measured, respectively, and an average value thereof was taken as the single plate orthogonal transmittance. Of the test modes (1) and (2) described above, the test mode (2) was adopted in the example of the invention.

### [Production of Liquid Crystal Display Devices 1 to 33]

Two polarizing plates were peeled away from a commercially-available IPS mode liquid crystal television set (42LS5600, produced by LG Electronics Inc.) and the polarizing plates prepared above were stuck through an adhesive to the front side and the rear side of the device, respectively, in the combination described in Table 2. The polarizing plates were arranged in a cross-Nicol configuration where the absorption axis of the polarizing plate on the front side was set in the longitudinal direction (horizontal direction) and the transmission axis of the polarizing plate on the rear side was set in longitudinal direction (horizontal direction). The thickness of the glass used in the liquid crystal cell was 0.5 mm. Thus, Liquid crystal display devices 1 to 33 having the configuration shown in Table 2 were produced, respectively.

### [Production of Liquid Crystal Display Devices 34 to 39]

Two polarizing plates were peeled away from a commercially-available VA mode liquid crystal television set (39E61HR, produced by Skyworth) and the polarizing plates prepared above were stuck through an adhesive to the front side and the rear side of the device, respectively, in the combination described in Table 2. The polarizing plates were arranged in a cross-Nicol configuration where the absorption axis of the polarizing plate on the front side was set in the longitudinal direction (horizontal direction) and the transmission axis of the polarizing plate on the rear side was set in longitudinal direction (horizontal direction). The thickness of the glass used in the liquid crystal cell was 0.5 mm. Thus, Liquid crystal display devices 34 to 39 having the configuration shown in Table 2 were produced, respectively.

### <Evaluation of Liquid Crystal Display Device>

### (1) Evaluation of Display Unevenness

The liquid crystal display device was subjected to a thermal test at 50° C. and relative humidity of 80% for 72 hours and allowed to stand at 25° C. and relative humidity of 60% for 2 hours. Then, a backlight of the liquid crystal display device was lit and 10 hours after the lighting, the light leakage at the four corners of the panel was evaluated comparatively with the standard panel in a dark room to evaluate the display unevenness.

Also, a black display screen of the evaluation panel was shot from the front of the screen by a brightness measuring camera (ProMetric, produced by Radiant Imaging Co.) and a brightness difference between average brightness of the entire screen and the brightness in the areas of four corners having a large light leakage was calculated, thereby quantifying a light leakage difference ΔL to the standard panel according to the formula shown below.

ΔL=(light leakage of standard panel)−(light leakage of evaluation panel)

The evaluation results and the standard panels for comparison with the respective liquid display devices are shown in Table 2 below.

D: The light leakage difference to the standard panel is visually recognized more definitely and the light leakage is unacceptable (0.04 cd/m²<ΔL).
C: The light leakage difference to the standard panel is visually recognized definitely and the light leakage is unacceptable (0.03 cd/m²<ΔL 0.04 cd/m²).
B: The light leakage difference to the standard panel is visually recognized to a slight extent and the light leakage is acceptable (0.01 cd/m²<ΔL 0.03 cd/m²).
A: The light leakage difference to the standard panel is not recognized and the light leakage is acceptable (ΔL≦0.01 cd/m²).

### (2) Evaluation of Warp of Liquid Crystal Cell

The liquid crystal display device was subjected to a thermal test at 50° C. and relative humidity of 80% for 72 hours and allowed to stand at 25° C. and relative humidity of 60% for 2 hours. Then, a backlight of the liquid crystal display device was lit and 10 hours after the lighting, the liquid crystal display device was deconstructed to take out the liquid crystal cell. The warp shape of the liquid crystal cell was a concave shape as seen from the viewing side in the longitudinal direction. Then, the liquid crystal cell was fixed in the state of upright position and a warp amount of the liquid crystal cell in the longitudinal direction was evaluated using a laser displacement meter. Also, a warp reduction rate to the standard panel was calculated from the warp amount according to the formula shown below. The evaluation results and the standard panels for comparison with the respective liquid display devices are shown in Table 2 below.

Warp reduction rate (%)=(warp amount of evaluation panel)/(warp amount of standard panel)×100

### (3) Evaluation of Display Performance

### (3)-1 Viewing Angle Contrast (Contrast in Oblique Direction)

The brightness values at the black display and white display at an azimuth angle of 45° or 135° were measured at a polar angle of 60° from the front of the device using a measuring instrument (BM5A, produced by TOPCON Corp.) in a dark room. Using an average value of the viewing angle contrasts at the azimuth angles of 45° and 135°, the viewing angle contrast of the liquid crystal display device was evaluated. Also, various images were displayed and the visibility from the front of the device to the polar angle of 60° in two directions of the azimuth angle of 45° and 135° was functionally evaluated.

A: The contour of image is clearly visible even in oblique direction (viewing angle contrast of 15 or more).
B: Although the contour of image is unclear at the polar angle larger than 45°, the contour of image is clear at the polar angle of 45° or less and there is no problem in practical use (viewing angle contrast from 10 to less than 15).
C: The contour of image is unclear at the polar angle of 45° and there is a problem in practical use in some cases (viewing angle contrast less than 10).

### (3)-2 Viewing Angle Tint (Black Tint in an Oblique Direction)

The tint at the black display at an azimuth angle from 0 to 360° was functionally evaluated at a polar angle of 60° from the front of the device. Since the display quality is significantly degraded when yellow or green is mixed in the black tint change, the evaluation criteria of the functional evaluation are set as shown below.

A: The black tint changes from blue to red and is acceptable as the display quality.
B: Yellow or green is mixed in the black tint and the display quality is significantly bad.

In Table 2 below, the symbol “-” in the display performance column indicates that the evaluation has not been performed.

In Liquid crystal display devices 22 and 24, due to the tension at the production of liquid crystal display device optical unevenness occurred and the significant degradation of display performance was observed.

TABLE 2

| | | | | | | Rear Side Polarizing Plate | | |
|---|---|---|---|---|---|---|---|---|
| | Front Side Polarizing Plate | | | | | | Light | |
| | Surface | Viewing | Cell | Sticking | | Cell | Source | Sticking |
| | Layer | Side | Side | Method | Liquid Crystal Cell | Side | Side | Method |
| Liquid Crystal Display | Hardcoat | Film 7 | Film 7 | A | 42LS5600 Produced by LG | Film 7 | Film 7 | A |
| Device 1 | Layer | | | | | | | |
| Liquid Crystal Display | Hardcoat | Film 8 | Film 8 | A | 42LS5600 Produced by LG | Film 8 | Film 8 | A |
| Device 2 | Layer | | | | | | | |
| Liquid Crystal Display | Hardcoat | Film 1 | Film 1 | A | 42LS5600 Produced by LG | Film 1 | Film 1 | A |
| Device 3 | Layer | | | | | | | |
| Liquid Crystal Display | Hardcoat | Film 1 | Film 1 | B | 42LS5600 Produced by LG | Film 1 | Film 1 | B |
| Device 4 | Layer | | | | | | | |
| Liquid Crystal Display | Hardcoat | Film 2 | Film 2 | A | 42LS5600 Produced by LG | Film 2 | Film 2 | A |
| Device 5 | Layer | | | | | | | |
| Liquid Crystal Display | Hardcoat | Film 3 | Film 3 | A | 42LS5600 Produced by LG | Film 3 | Film 3 | A |
| Device 6 | Layer | | | | | | | |
| Liquid Crystal Display | Hardcoat | Film 9 | Film 9 | A | 42LS5600 Produced by LG | Film 9 | Film 9 | A |
| Device 7 | Layer | | | | | | | |
| Liquid Crystal Display | Hardcoat | Film 14 | Film 14 | A | 42LS5600 Produced by LG | Film 14 | Film 14 | A |
| Device 8 | Layer | | | | | | | |
| Liquid Crystal Display | Hardcoat | Film 10 | Film 10 | A | 42LS5600 Produced by LG | Film 10 | Film 10 | A |
| Device 9 | Layer | | | | | | | |
| Liquid Crystal Display | Hardcoat | Film 11 | Film 11 | A | 42LS5600 Produced by LG | Film 11 | Film 11 | A |
| Device 10 | Layer | | | | | | | |
| Liquid Crystal Display | Hardcoat | Film 4 | Film 4 | A | 42LS5600 Produced by LG | Film 4 | Film 4 | A |
| Device 11 | Layer | | | | | | | |
| Liquid Crystal Display | Hardcoat | Film 5 | Film 5 | A | 42LS5600 Produced by LG | Film 5 | Film 5 | A |
| Device 12 | Layer | | | | | | | |
| Liquid Crystal Display | Hardcoat | Film 6 | Film 6 | A | 42LS5600 Produced by LG | Film 6 | Film 6 | A |
| Device 13 | Layer | | | | | | | |
| Liquid Crystal Display | Hardcoat | Film 12 | Film 12 | A | 42LS5600 Produced by LG | Film 12 | Film 12 | A |
| Device 14 | Layer | | | | | | | |
| Liquid Crystal Display | Hardcoat | Film 15 | Film 15 | A | 42LS5600 Produced by LG | Film 15 | Film 15 | A |
| Device 15 | Layer | | | | | | | |
| Liquid Crystal Display | Hardcoat | Film 21 | Film 21 | A | 42LS5600 Produced by LG | Film 21 | Film 21 | A |
| Device 16 | Layer | | | | | | | |
| Liquid Crystal Display | Hardcoat | Film 16 | Film 16 | A | 42LS5600 Produced by LG | Film 16 | Film 16 | A |
| Device 17 | Layer | | | | | | | |
| Liquid Crystal Display | Hardcoat | Film 17 | Film 17 | A | 42LS5600 Produced by LG | Film 17 | Film 17 | A |
| Device 18 | Layer | | | | | | | |
| Liquid Crystal Display | Hardcoat | Film 18 | Film 18 | A | 42LS5600 Produced by LG | Film 18 | Film 18 | A |
| Device 19 | Layer | | | | | | | |
| Liquid Crystal Display | Hardcoat | Film 19 | Film 19 | A | 42LS5600 Produced by LG | Film 19 | Film 19 | A |
| Device 20 | Layer | | | | | | | |
| Liquid Crystal Display | Hardcoat | Film 20 | Film 20 | A | 42LS5600 Produced by LG | Film 20 | Film 20 | A |
| Device 21 | Layer | | | | | | | |
| Liquid Crystal Display | Hardcoat | Film 13 | Film 13 | A | 42LS5600 Produced by LG | Film 13 | Film 13 | A |
| Device 22 | Layer | | | | | | | |
| Liquid Crystal Display | Hardcoat | Film 22 | Film 22 | A | 42LS5600 Produced by LG | Film 22 | Film 22 | A |
| Device 23 | Layer | | | | | | | |
| Liquid Crystal Display | Hardcoat | Film 23 | Film 23 | A | 42LS5600 Produced by LG | Film 23 | Film 23 | A |
| Device 24 | Layer | | | | | | | |
| Liquid Crystal Display | Hardcoat | Film 24 | Film 7 | A | 42LS5600 Produced by LG | Film 7 | Film 24 | A |
| Device 25 | Layer | | | | | | | |
| Liquid Crystal Display | Hardcoat | Film 24 | Film 1 | A | 42LS5600 Produced by LG | Film 1 | Film 24 | A |
| Device 26 | Layer | | | | | | | |
| Liquid Crystal Display | Hardcoat | Film 24 | Film 1 | B | 42LS5600 Produced by LG | Film 1 | Film 24 | B |
| Device 27 | Layer | | | | | | | |
| Liquid Crystal Display | Hardcoat | Film 13 | Film 7 | A | 42LS5600 Produced by LG | Film 7 | Film 13 | A |
| Device 28 | Layer | | | | | | | |
| Liquid Crystal Display | Hardcoat | Film 13 | Film 1 | A | 42LS5600 Produced by LG | Film 1 | Film 13 | A |
| Device 29 | Layer | | | | | | | |
| Liquid Crystal Display | Hardcoat | Film 25 | Film 7 | A | 42LS5600 Produced by LG | Film 7 | Film 25 | A |
| Device 30 | Layer | | | | | | | |
| Liquid Crystal Display | Hardcoat | Film 25 | Film 1 | A | 42LS5600 Produced by LG | Film 1 | Film 25 | A |
| Device 31 | Layer | | | | | | | |
| Liquid Crystal Display | Hardcoat | Film 7 | Film 26 | A | 42LS5600 Produced by LG | Film 26 | Film 7 | A |
| Device 32 | Layer | | | | | | | |
| Liquid Crystal Display | Hardcoat | Film 1 | Film 26 | A | 42LS5600 Produced by LG | Film 26 | Film 1 | A |
| Device 33 | Layer | | | | | | | |
| Liquid Crystal Display | Hardcoat | Film 7 | Film 27 | A | 39E61HR Produced by | Film 27 | Film 7 | A |
| Device 34 | Layer | | | | Skyworth | | | |
| Liquid Crystal Display | Hardcoat | Film 1 | Film 27 | A | 39E61HR Produced by | Film 27 | Film 1 | A |
| Device 35 | Layer | | | | Skyworth | | | |
| Liquid Crystal Display | Hardcoat | Film 7 | Film 28 | A | 39E61HR Produced by | Film 28 | Film 7 | A |
| Device 36 | Layer | | | | Skyworth | | | |
| Liquid Crystal Display | Hardcoat | Film 1 | Film 28 | A | 39E61HR Produced by | Film 28 | Film 1 | A |
| Device 37 | Layer | | | | Skyworth | | | |
| Liquid Crystal Display | Hardcoat | Film 7 | Film 29 | A | 39E61HR Produced by | Film 29 | Film 7 | A |
| Device 38 | Layer | | | | Skyworth | | | |
| Liquid Crystal Display | Hardcoat | Film 1 | Film 29 | A | 39E61HR Produced by | Film 29 | Film 1 | A |
| Device 39 | Layer | | | | Skyworth | | | |

| | Evaluation of Liquid Crystal Display Device | | | | | | |
|---|---|---|---|---|---|---|---|
| | | Warp of Liquid | | | Display | | |
| | | Crystal Cell | | | Performance | | |
| | | Warp | Warp | | Viewing | | |
| | Display | Amount | Reduction | Standard for | Angle | | |
| | Unevenness | (mm) | Rate (%) | Comparison | Contrast | Tint | Remarks |
| Liquid Crystal Display | — | 7.2 | — | — | A | A | Comparative |
| Device 1 | | | | | | | Example |
| Liquid Crystal Display | C | 7.1 | 99 | Liquid Crystal Display | A | A | Comparative |
| Device 2 | | | | Device 1 | | | Example |
| Liquid Crystal Display | B | 6.7 | 92 | Liquid Crystal Display | A | A | Example |
| Device 3 | | | | Device 1 | | | |
| Liquid Crystal Display | B | 6.7 | 92 | Liquid Crystal Display | A | A | Example |
| Device 4 | | | | Device 1 | | | |
| Liquid Crystal Display | A | 6.0 | 84 | Liquid Crystal Display | A | A | Example |
| Device 5 | | | | Device 1 | | | |
| Liquid Crystal Display | B | 6.6 | 91 | Liquid Crystal Display | A | A | Example |
| Device 6 | | | | Device 1 | | | |
| Liquid Crystal Display | B | 6.5 | 91 | Liquid Crystal Display | B | B | Example |
| Device 7 | | | | Device 1 | | | |
| Liquid Crystal Display | A | 6.1 | 85 | Liquid Crystal Display | B | B | Example |
| Device 8 | | | | Device 1 | | | |
| Liquid Crystal Display | — | 7.2 | — | — | A | A | Comparative |
| Device 9 | | | | | | | Example |
| Liquid Crystal Display | C | 7.1 | 99 | Liquid Crystal Display | A | A | Comparative |
| Device 10 | | | | Device 9 | | | Example |
| Liquid Crystal Display | B | 6.7 | 92 | Liquid Crystal Display | A | A | Example |
| Device 11 | | | | Device 9 | | | |
| Liquid Crystal Display | A | 6.0 | 84 | Liquid Crystal Display | A | A | Example |
| Device 12 | | | | Device 9 | | | |
| Liquid Crystal Display | B | 6.6 | 91 | Liquid Crystal Display | A | A | Example |
| Device 13 | | | | Device 9 | | | |
| Liquid Crystal Display | B | 6.5 | 91 | Liquid Crystal Display | A | A | Example |
| Device 14 | | | | Device 9 | | | |
| Liquid Crystal Display | A | 6.1 | 85 | Liquid Crystal Display | B | B | Example |
| Device 15 | | | | Device 9 | | | |
| Liquid Crystal Display | — | 7.1 | — | — | A | A | Comparative |
| Device 16 | | | | | | | Example |
| Liquid Crystal Display | B | 6.8 | 95 | Liquid Crystal Display | A | A | Example |
| Device 17 | | | | Device 16 | | | |
| Liquid Crystal Display | A | 6.3 | 89 | Liquid Crystal Display | A | A | Example |
| Device 18 | | | | Device 16 | | | |
| Liquid Crystal Display | B | 6.5 | 91 | Liquid Crystal Display | A | A | Example |
| Device 19 | | | | Device 16 | | | |
| Liquid Crystal Display | B | 6.4 | 90 | Liquid Crystal Display | B | B | Example |
| Device 20 | | | | Device 16 | | | |
| Liquid Crystal Display | B | 6.4 | 90 | Liquid Crystal Display | B | B | Example |
| Device 21 | | | | Device 16 | | | |
| Liquid Crystal Display | — | — | — | — | C | B | Comparative |
| Device 22 | | | | | | | Example |
| Liquid Crystal Display | C | 7.0 | 97 | Liquid Crystal Display | A | A | Comparative |
| Device 23 | | | | Device 1 | | | Example |
| Liquid Crystal Display | — | — | — | — | C | B | Comparative |
| Device 24 | | | | | | | Example |
| Liquid Crystal Display | — | 8.2 | — | — | A | A | Comparative |
| Device 25 | | | | | | | Example |
| Liquid Crystal Display | B | 7.8 | 95 | Liquid Crystal Display | A | A | Example |
| Device 26 | | | | Device 25 | | | |
| Liquid Crystal Display | B | 7.8 | 95 | Liquid Crystal Display | A | A | Example |
| Device 27 | | | | Device 25 | | | |
| Liquid Crystal Display | — | 4.1 | — | — | A | A | Comparative |
| Device 28 | | | | | | | Example |
| Liquid Crystal Display | B | 3.9 | 95 | Liquid Crystal Display | A | A | Example |
| Device 29 | | | | Device 28 | | | |
| Liquid Crystal Display | — | 4.5 | — | — | A | A | Comparative |
| Device 30 | | | | | | | Example |
| Liquid Crystal Display | B | 4.2 | 94 | Liquid Crystal Display | A | A | Example |
| Device 31 | | | | Device 30 | | | |
| Liquid Crystal Display | — | 7.4 | — | — | A | A | Comparative |
| Device 32 | | | | | | | Example |
| Liquid Crystal Display | B | 7.0 | 95 | Liquid Crystal Display | A | A | Example |
| Device 33 | | | | Device 32 | | | |
| Liquid Crystal Display | — | 7.1 | — | — | — | — | Comparative |
| Device 34 | | | | | | | Example |
| Liquid Crystal Display | B | 6.7 | 94 | Liquid Crystal Display | — | — | Example |
| Device 35 | | | | Device 34 | | | |
| Liquid Crystal Display | — | 7.1 | — | — | — | — | Comparative |
| Device 36 | | | | | | | Example |
| Liquid Crystal Display | B | 6.7 | 94 | Liquid Crystal Display | — | — | Example |
| Device 37 | | | | Device 36 | | | |
| Liquid Crystal Display | — | 3.7 | — | — | — | — | Comparative |
| Device 38 | | | | | | | Example |
| Liquid Crystal Display | B | 3.5 | 95 | Liquid Crystal Display | — | — | Example |
| Device 39 | | | | Device 38 | | | |

What is claimed is:

1. An optical film which comprises an acrylic resin, in which at least one of a modulus of elongation on a machine direction and a modulus of elongation on a direction vertical to the machine direction is less than 2.3×10⁹ N/m² and an in-plane retardation value Re (nm) of the optical film represented by the following formula (i) satisfies the following formula (ia):
Re=(nx−ny)×d Formula (i)
ΔRe=Re(10)−Re(0)≦10 Formula (ia)
wherein, in the formulae, nx represents a refractive index in an in-plane slow axis direction of the optical film, ny represents a refractive index in an in-plane fast axis direction of the optical film, d represents a thickness (nm) of the optical film, Re(10) represents a retardation value when the optical film is stretched 10%, and Re(0) represents a retardation value in an unstretched state of the optical film.

2. The optical film as claimed in claim 1, which comprises an elastic modulus reducing agent which satisfies the following formula (1):
(E(A)−E(0))/A≦−0.01(×10⁹ N/m²% by weight) Formula (1)
wherein, in the formula (1), A represents a content ratio (% by weight) of the elastic modulus reducing agent in the optical film, E(A) represents a modulus of elongation of the optical film containing A % by weight of the elastic modulus reducing agent, and E(0) represents a modulus of elongation of the optical film not containing the elastic modulus reducing agent.

3. The optical film as claimed in claim 1, wherein the acrylic resin has a repeating unit derived from an elastic modulus reducing monomer which satisfies the following formula (2):
(E2(A2)−E2(0))/A2≦−0.01(×10⁹ N/m²% by weight) Formula (2)
wherein, in the formula (2), A2 represents a content ratio (% by weight) of the repeating unit derived from an elastic modulus reducing monomer in the acrylic resin, E2(A2) represents a modulus of elongation of the optical film containing A2% by weight of the repeating unit derived from an elastic modulus reducing monomer in the acrylic resin, and E2(0) represents a modulus of elongation of the optical film not containing the repeating unit derived from an elastic modulus reducing monomer in the acrylic resin.

4. The optical film as claimed in claim 2, which satisfies the following formula (3):
Tg(C)−Tg(D)≧−5(° C.) Formula (3)
wherein, in the formula (3), Tg(C) represents a glass transition temperature of the optical film containing the elastic modulus reducing agent, and Tg(D) represents a glass transition temperature of the optical film not containing the elastic modulus reducing agent.

5. The optical film as claimed in claim 2, wherein the elastic modulus reducing agent is a rubber polymer.

6. The optical film as claimed in claim 2, wherein the elastic modulus reducing agent is a compound compatible with the acrylic resin.

7. The optical film as claimed in claim 3, wherein the elastic modulus reducing monomer is an acrylate having a glass transition temperature of 25° C. or less.

8. The optical film as claimed in claim 1, wherein the acrylic resin is a polymer containing a lactone ring structure in a main chain or a polymer containing a glutarimide ring structure in a main chain.

9. The optical film as claimed in claim 1, wherein an in-plane retardation value Re (nm) of the optical film represented by the following formula (i) and a thickness direction retardation value Rth (nm) of the optical film represented by the following formula (ii) satisfy the following formulae (iii) and (iv):
Re=(nx−ny)×d Formula (i)
Rth=((nx+ny)/2−nz)×d Formula (ii)
0≦Re<20 nm Formula (iii)

|Rth|≦25 nm Formula (iv)
wherein, in the formulae, nx represents a refractive index in an in-plane slow axis direction of the optical film, ny represents a refractive index in an in-plane fast axis direction of the optical film, nz represents a refractive index in a thickness direction of the optical film, and d represents a thickness (nm) of the optical film.

10. The optical film as claimed in claim 1, wherein at least one of a pattern retardation layer, a λ/4 layer, an optically anisotropic layer, a hardcoat layer, an antiglare layer, an antireflective layer, an antistatic layer and an easy adhesion layer is provided at a surface of the optical film.

11. A polarizing plate comprising a polarizer and the optical film as claimed in claim 1 provided at at least one side of the polarizer.

12. The polarizing plate as claimed in claim 11, wherein the optical film is provided at both sides of the polarizer.

13. A liquid crystal display device comprising at least one of the polarizing plate as claimed in claim 11.
